(19) United States
(12) Patent Application Publication
(10) Pub. No.: US 2024/0359952 A1
(43) Pub. Date: Oct. 31, 2024

(54) OFFSHORE LIFTING SYSTEM

(71) Applicant: Pugh Acquisition Co., Corpus Christi, TX (US)

(72) Inventors: Michael F.D. Cadigan, Houston, TX (US); Paul Liberato, Richmond, TX (US)

(21) Appl. No.: 18/649,680

(22) Filed: Apr. 29, 2024

Related U.S. Application Data
(60) Provisional application No. 63/462,959, filed on Apr. 28, 2023.
(60) Provisional application No. 63/463,225, filed on May 1, 2023.

(51) Int. Cl. B66C 1/14; B66C 13/08

(52) U.S. Cl. CPC B66C 1/14; B66C 13/08

(57) ABSTRACT

An offshore lifting system includes a lifting frame, lifting lugs at corners of the lifting frame, and a plurality of hooks attached to opposing interior surfaces of the lifting frame. In some embodiments, a pair of lower lifting bars may be suspended from slings coupled to respective ones of the plurality of hooks, the lifting frame and the lower lifting bars configured for containment of a first payload. In some embodiments, a pair of polyester slings may be coupled to respective ones of the plurality of hooks, the lifting frame and the pair of polyester slings configured for containment of the first payload. In some embodiments, lifting handles of a second payload are configured for attachment to respective first ones of the plurality of hooks. A cargo net may be attached to respective second ones of the plurality of hooks, where the cargo net surrounds and contains the second payload.

### CROSS-REFERENCE TO RELATED APPLICATIONS

The present application claims benefit, under 35 U.S.C. 119(e), of U.S. Provisional Application No. 63/462,959, filed Apr. 28, 2023, and of U.S. Provisional Application No. 63/463,225, filed May 1, 2023, the disclosures of which are incorporated by reference herein.

### FIELD OF THE DISCLOSURE

This disclosure relates generally to an offshore lifting system, and, more particularly, to a multi-purpose offshore lifting system, and related methods, for lifting intermediate bulk containers (IBCs), flexible intermediate bulk containers (FIBCs), and palleted loads.

### BACKGROUND

In the course of operation, offshore upstream oil and gas businesses may utilize IBCs, FIBCs, or palleted loads to handle, transport, or store liquids, solids, semi-solids, pastes, or other types of material. Often, there is a need to lift, position, or transport an IBC, FIBC, or palleted load shipboard, ship-to-ship, etc. In various examples, a below-the-hook lifting device, attached to a crane or other hoisting means, may be used for lifting, positioning, and transporting loads such as IBCs, FIBCs, or palleted loads. Such loads often weigh thousands of pounds, can result in lateral loading (e.g., such as when transporting fluids), and should be handled with great care. Yet, in some existing implementations, these loads may be lifted with unsafe equipment that is prone to failure and that may result in a dropped load during operation. This poses a significant risk of personal injury to personnel in proximity to the lift. In addition to the potential of injury to personnel, the below-the-hook lifting device and/or the load itself may be damaged, which will result in loss of productivity and increased expense. Thus, existing techniques have not proved entirely satisfactory in all respects.

### SUMMARY

Systems and methods have been provided for lifting IBCs, FIBCs, and palleted loads using a multi-purpose offshore lifter.

In some embodiments in accordance with the present invention, an offshore lifting system includes an upper lifting frame, a radiused lifting lug disposed at each corner of the upper lifting frame and along a top surface of the upper lifting frame, and a plurality of weld-on hooks attached to opposing interior surfaces of the upper lifting frame and adjacent to corners of the upper lifting frame. In some embodiments, in a first configuration of a first mode of operation, a pair of lower lifting bars are suspended from slings of a first length coupled to respective ones of the plurality of weld-on hooks along the opposing interior surfaces of the upper lifting frame, where the upper lifting frame and the lower lifting bars are configured for lateral and vertical containment of a rigid container. In some embodiments, in a second mode of operation, lifting handles of a flexible container are configured for attachment to respective first ones of the plurality of weld-on hooks at each corner of the upper lifting frame. In some embodiments, a cargo net is attached to respective second ones of the plurality of weld-on hooks at each corner of the upper lifting frame, where the cargo net surrounds and contains the flexible container.

In some embodiments, in a second configuration of the first mode of operation, a pair of polyester slings are coupled to the respective ones of the plurality of weld-on hooks along the opposing interior surfaces of the upper lifting frame, where the upper lifting frame and the pair of polyester slings are configured for lateral and vertical containment of the rigid container.

In some embodiments, in a third mode of operation, the pair of lower lifting bars are suspended from slings of a second length coupled to respective ones of the plurality of weld-on hooks along the opposing interior surfaces of the upper lifting frame, where the second length is longer than the first length, and where the upper lifting frame and the lower lifting bars are configured for containment of a palleted load.

In some embodiments, the pair of lower lifting bars used in the third mode of operation are longer than the pair of lifting bars used in the first configuration of the first mode of operation.

In some embodiments, the upper lifting frame has a substantially square shape from a top view.

In some embodiments, the rigid container includes an intermediate bulk container (IBC) and the flexible container includes a flexible IBC (FIBC).

In some embodiments, each of the radiused lifting lugs are configured for attachment of a respective sling for coupling the upper lifting frame to a master link assembly.

In some embodiments, each of the respective slings configured for attachment to each of the radiused lifting lugs have an equal length.

In some embodiments, an angle from vertical for each of the respective slings, configured for attachment to each of the radiused lifting lugs, is equal to about 30 degrees during transport by the offshore lifting system.

In some embodiments, at least in the first configuration of the first mode of operation, an angle from vertical for the slings used to suspend the pair of lower lifting bars is equal to about 0 degrees.

In some embodiments, the upper lifting frame includes one or more handles coupled to a top surface of the upper lifting frame.

In some embodiments, the offshore lifting system further includes a bumper attached to an interior surface of a side of the upper lifting frame between a set of weld-on hooks of the plurality of weld-on hooks attached at opposing lateral ends of the interior surface along the side of the upper lifting frame.

In some embodiments, the bumper includes a cylindrical pipe with a radiused surface.

In some embodiments in accordance with the present invention, a lifting device includes a rectilinear frame assembly. In some embodiments, the rectilinear frame assembly circumscribes a payload region at least from a top-down view of the lifting device, where the payload region is configured to receive a payload. In some embodiments, the lifting device further includes padeyes protruding from a top portion of the rectilinear frame assembly at each corner of the rectilinear frame assembly, a plurality of hooks attached to an interior surface of the rectilinear frame assembly and adjacent to each corner of the rectilinear frame assembly, and an upper sling set attached to respective ones of the padeyes. In some embodiments, first ones of the plurality of hooks are configured to support the payload. In some embodiments, the rectilinear frame assembly and the payload are configured to be lifted using the upper sling set.

In some embodiments, each sling of the upper sling set has an equal length.

In some embodiments, the lifting device further includes a bumper attached to at least two opposing interior surfaces of the rectilinear frame assembly.

In some embodiments, the bumper includes a cylindrical pipe with a radiused surface.

In some embodiments, the lifting device further includes a first lifting bar suspended from first and second vertical slings coupled to first and second hooks of the plurality of hooks, the first and second hooks attached to opposing interior surfaces of the rectilinear frame assembly. In some embodiments, the lifting device further includes a second lifting bar suspended, parallel to the first lifting bar, from third and fourth vertical slings coupled to third and fourth hooks of the plurality of hooks, the third and fourth hooks attached to the opposing interior surfaces of the rectilinear frame assembly.

In some embodiments, the rectilinear frame assembly and the first and second lifting bars are configured for lateral and vertical containment of the payload.

In some embodiments, the lifting device further includes a first polyester sling coupled to first and second hooks of the plurality of hooks, the first and second hooks attached to opposing interior surfaces of the rectilinear frame assembly. In some embodiments, the lifting device further includes a second polyester sling coupled to third and fourth hooks of the plurality of hooks, the third and fourth hooks attached to opposing interior surfaces of the rectilinear frame assembly.

In some embodiments, the rectilinear frame assembly and the first and second polyester slings are configured for lateral and vertical containment of the payload.

In some embodiments, the lifting device further includes a cargo net coupled to and suspended from second ones of the plurality of hooks adjacent to each corner of the rectilinear frame assembly, where the cargo net is configured to surround and contain the payload.

In some embodiments, the cargo net includes an opening aligned with a bottom portion of the payload.

In some embodiments, the payload includes a flexible container having lifting handles, and the lifting device further includes spacer slings having first ends coupled to the first ones of the plurality of hooks adjacent to each corner of the rectilinear frame assembly, the spacer slings further having second ends coupled to both the handles of the flexible container and the cargo net.

In some embodiments, the lifting device further includes one or more handles attached to a top side of the rectilinear frame assembly.

In some embodiments in accordance with the present invention, a lifting device includes a rectilinear lifting frame having plural sides, where each of the plural sides includes an interior surface that faces an opposing interior surface of another one of the plural sides. In some embodiments, the lifting device further includes a first set of inward facing hooks attached to the interior surface at lateral ends of a first one of the plural sides adjacent to first and second corners of the rectilinear lifting frame. In some embodiments, the lifting device further includes a second set of inward facing hooks attached to the interior surface at lateral ends of a second one of the plural sides adjacent to third and fourth corners of the rectilinear lifting frame, where the first one of the plural sides faces the second one of the plural sides.

In some embodiments, a region circumscribed by the rectilinear lifting frame is configured to receive a payload, where the plural sides of the rectilinear lifting frame are configured to laterally contain the payload.

In some embodiments, each of the plural sides has an equal length.

In some embodiments, the lifting device further includes a radiused padeye extending from a top side of the rectilinear lifting frame at each of the first, second, third, and fourth corners.

In some embodiments, the radiused padeyes are configured for attachment of a set of slings by which the rectilinear lifting frame and a payload are lifted.

In some embodiments, each sling of the set of slings has an equal length.

In some embodiments, the lifting device further includes a first bumper attached to the interior surface of the first one of the plural sides between the first set of inward facing hooks, and a second bumper attached to the interior surface of the second one of the plural sides between the second set of inward facing hooks.

In some embodiments, the first and second bumpers include a cylindrical pipe with a radiused surface.

In some embodiments, the lifting device further includes a first lower lifting bar suspended from first and second slings coupled to first and second inward facing hooks of respective ones of the first and second sets of inward facing hooks. In some embodiments, the lifting device further includes a second lower lifting bar suspended, parallel to the first lower lifting bar, from third and fourth slings coupled to third and fourth inward facing hooks of respective ones of the first and second sets of inward facing hooks.

In some embodiments, the lifting device further includes a cargo net coupled to and suspended from inward facing hooks next to each of the first, second, third, and fourth inward facing hooks and adjacent to each of the first, second, third, and fourth corners, where the cargo net is configured to surround and contain the first and second lower lifting bars and a payload received within a region circumscribed by the rectilinear lifting frame.

In some embodiments, the lifting device further includes a handle attached to a top side of the rectilinear lifting frame and adjacent to each inward facing hook of the first and second sets of inward facing hooks.

### BRIEF DESCRIPTION OF THE DRAWINGS

FIG. 1A illustrates an exemplary intermediate bulk container (IBC), in accordance with some embodiments.

FIG. 1B illustrates an exemplary flexible intermediate bulk container (FIBC), in accordance with some embodiments.

FIGS. 2A, 2B, 2C and 2E illustrate various embodiments of an offshore lifting system in an IBC mode, in accordance with some embodiments.

FIG. 2D provides a detailed view of an exemplary sling for use in the offshore lifting system, in accordance with some embodiments.

FIG. 3 illustrates an embodiment of the offshore lifting system in an FIBC mode, in accordance with some embodiments.

FIG. 4 illustrates an embodiment of the offshore lifting system in a pallet mode, in accordance with some embodiments.

FIG. 5 illustrates a portion of the offshore lifting system including an upper lifting frame, in accordance with some embodiments.

FIG. 6 illustrates a portion of the offshore lifting system including a corner region of the upper lifting frame, in accordance with some embodiments.

FIG. 7 illustrates a portion of the offshore lifting system including an upper sling set, in accordance with some embodiments.

FIGS. 8A, 8B, 8C, 8D, and 8E provide various views of the offshore lifting system including various views of interior portions of the upper lifting frame that illustrate hooks and bumpers, in accordance with some embodiments.

FIGS. 9A and 9B illustrate portions of the upper lifting frame of the offshore lifting system including handles, in accordance with some embodiments.

FIG. 10A illustrates an embodiment of the offshore lifting system in the FIBC mode and including a cargo net, in accordance with some embodiments.

FIG. 10B illustrates an embodiment of the offshore lifting system in the FIBC mode, including the cargo net and spacer slings, in accordance with some embodiments.

FIG. 10C illustrates an embodiment of the offshore lifting system in the FIBC mode and includes the cargo net having an opening disposed along an underside of the FIBC, in accordance with some embodiments.

FIG. 10D illustrates an embodiment of the offshore lifting system in the pallet mode and including the cargo net, in accordance with some embodiments.

FIGS. 11, 12, 13, 14, and 15 provide general arrangement views of the offshore lifting system for each of the IBC mode, FIBC mode, and pallet mode, in accordance with some embodiments.

FIG. 16 provides a flow chart illustrating an embodiment of a method of using the offshore lifting system, in accordance with some embodiments.

Embodiments of the present disclosure may be understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Embodiments of the present disclosure include a multi-purpose offshore lifting system, and related methods, that may be used for lifting intermediate bulk containers (IBCs), flexible intermediate bulk containers (FIBCs), and palleted loads. In the discussion that follows, IBCs, FIBCs, and palleted loads may be referred to as “load(s)” or “payload(s)”. Additionally, and although not limited thereto, the disclosed multi-purpose offshore lifting system may be used to transfer a payload between a floating vessel (e.g., a ship) and an offshore drilling or production platform, between two different floating vessels (e.g., ship-to-ship), or between an offshore drilling or production platform and a floating vessel.

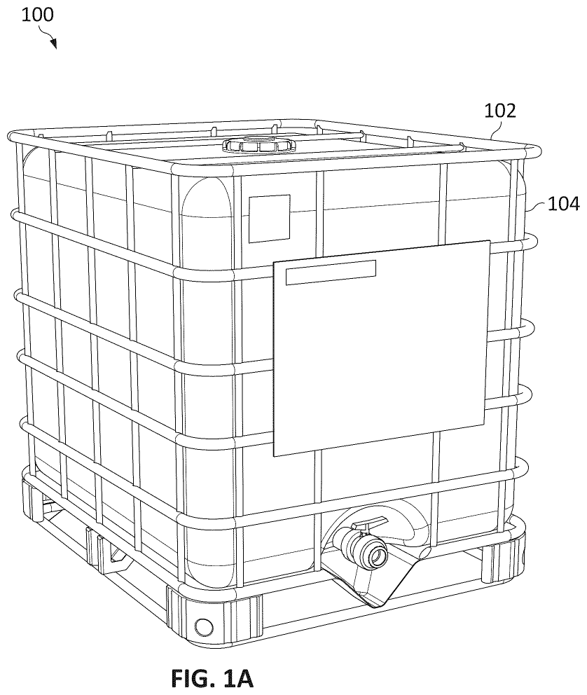

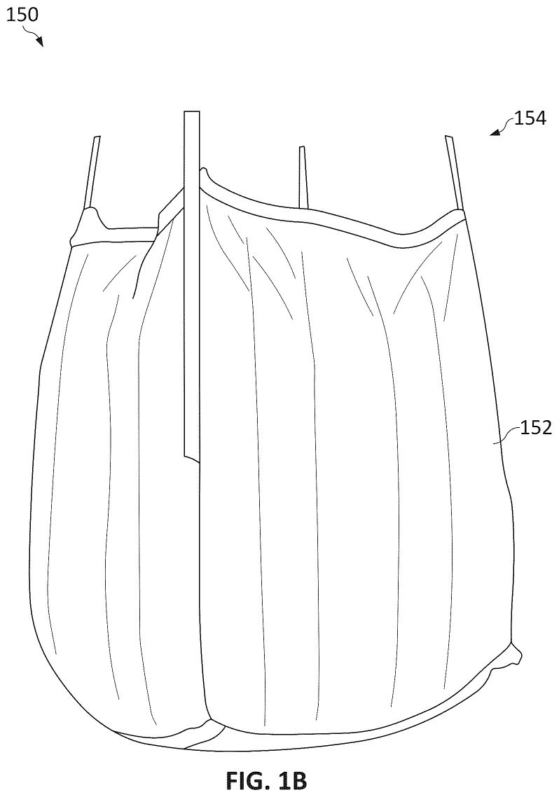

For purposes of this disclosure, an IBC may include a closed shipping vessel with a liquid capacity ranging from about 450-3,000 L (about 119-793 gallons). FIG. 1A illustrates an exemplary IBC 100 (or composite IBC 100). In some examples, the IBC 100 may include structural equipment in the form of a rigid outer casing 102 (e.g., such as a galvanized steel outer casing) enclosing a plastic inner receptacle 104 (e.g., such as a polyethylene or high-density polyethylene (HDPE) inner receptacle) together with any service or other structural equipment. The IBC 100 is constructed so that the inner receptacle 104 and the outer casing 102, once assembled, form and are used as, an integrated single unit to be filled, stored, transported, or emptied as such. While not limited to use with a particular size of IBC, in some embodiments, aspects of the present disclosure are designed for use with 275 gallon (1,040 liter) and 330 gallon (1,250 liter) IBCs.

FIG. 1B illustrates an exemplary FIBC 150. In some examples, the FIBC 150 may include a body 152 constituted of film, woven fabric, or any other flexible material or combinations thereof, and optionally an inner coating or liner, together with any appropriate service equipment and handling devices 154 (e.g., such as lifting straps or lifting loops). While not limited to use with a particular size of FIBC, in some embodiments, aspects of the present disclosure are designed for use with FIBCs having a footprint (base dimensions) in a range of from about 30″×30″ to about 48″×48″. Similarly, while not limited to use with a particular size of pallet, various embodiments of the present disclosure are designed for use with pallets having a pallet size of about 40″×48″ or about 48″×48″.

As discussed above, IBCs, FIBCs, or palleted loads may be used to handle, transport, or store liquids, solids, semi-solids, pastes, or other types of material. In particular, the lifting, positioning, and transporting of an IBC, FIBC, or palleted load may be accomplished by using a below-the-hook lifting device attached to a crane or other hoisting means. The weight of such loads, and the potential for lateral loading, can become particularly problematic when the loads are lifted with unsafe equipment (e.g., such as equipment prone to failure and which may result in a dropped load during operation). This situation poses a significant risk of personal injury, not to mention the potential damage caused to the below-the-hook lifting device and/or the load itself, which will result in loss of productivity and increased expense. Thus, existing techniques have not proved entirely satisfactory in all respects.

Embodiments of the present disclosure offer advantages over the existing art, though it is understood that other embodiments may offer different advantages, not all advantages are necessarily discussed herein, and no particular advantage is required for all embodiments. For example, embodiments discussed herein include a multi-purpose offshore lifting system, and related methods, that may be used for lifting IBCs, FIBCs, and palleted loads. It the discussion that follows, the multi-purpose offshore lifting system may, in some cases, be equivalently referred to as a multi-purpose offshore bulk lifter, a multi-mode offshore bulk lifter, an offshore bulk lifter, a bulk lifter, a lifting device, a lifter, a lifting system, a below-the-hook lifting device, a portable offshore unit, or other similar nomenclature. In accordance with the disclosed embodiments, the multi-purpose offshore lifting system is generally capable of operating in three different modes (e.g., depending on a configuration of the system) including an IBC mode (or tote mode), an FIBC mode, and a pallet mode. In some embodiments, the disclosed offshore lifting system includes an upper lifting frame from which an IBC, an FIBC, or a pallet may be suspended as a payload. In various cases, the lifter and payload (e.g., such as an IBC, FIBC, or palleted load) may be lifted and transported using a sling set attached at corners of the upper lifting frame, the sling set further coupled to a crane, hoist, or other lifting machine.

In accordance with the embodiments disclosed herein, the offshore lifting system and rigging arrangement may also provide for full load containment for IBC, FIBC, and palleted loads, for example, by having the offshore lifting system swallow, surround, or otherwise encapsulate the load. For example, in the IBC lifting mode, the offshore lifting system protects against potential lateral loading (e.g., such as when transporting fluids) by ensuring that the upper lifting frame of the offshore lifting system fully encapsulates the IBC tote. In the FIBC lifting mode, the upper lifting frame may also be configured to allow for attachment of a cargo net that surrounds and contains an FIBC bag during transport, thereby providing dropped object protection in the event that handles of the FIBC bag were to break. In some cases, in the IBC lifting mode or in a pallet lifting mode, a cargo net may similarly be used to surround and contain an IBC tote or a palleted load during transport, to provide an additional layer of containment and support.

In some examples, a maximum payload (working load limit) of the disclosed offshore lifting system may be at least about 2.5 MT, and the maximum payload may be independent of whether the multi-purpose offshore lifting system is used for lifting IBCs, FIBCs, or palleted loads. In various embodiments, the IBCs, FIBCs, or palleted loads may be lifted and transferred (e.g., by a crane, hoist, or other lifting machine) between a floating vessel (e.g., a ship) and an offshore drilling or production platform, between two different floating vessels (e.g., ship-to-ship), or between an offshore drilling or production platform and a floating vessel. Further, by way of example, an operational temperature range for the disclosed offshore lifting system may be in a range from about 0° C./32° F. to about 50° C./122° F. Additional details of embodiments of the present disclosure are provided below, and additional benefits and/or other advantages will become apparent to those skilled in the art having benefit of the present disclosure.

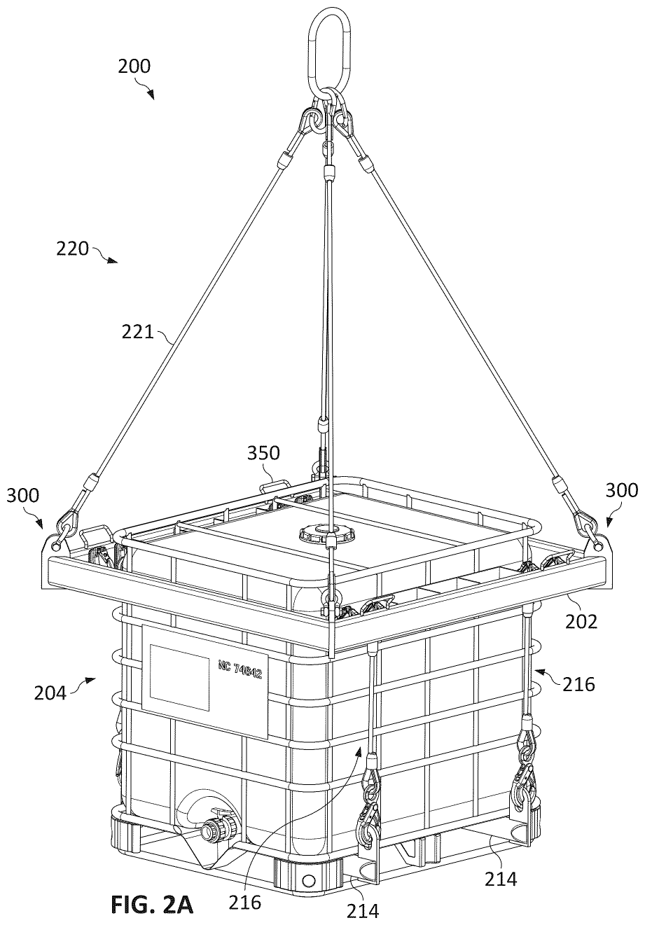

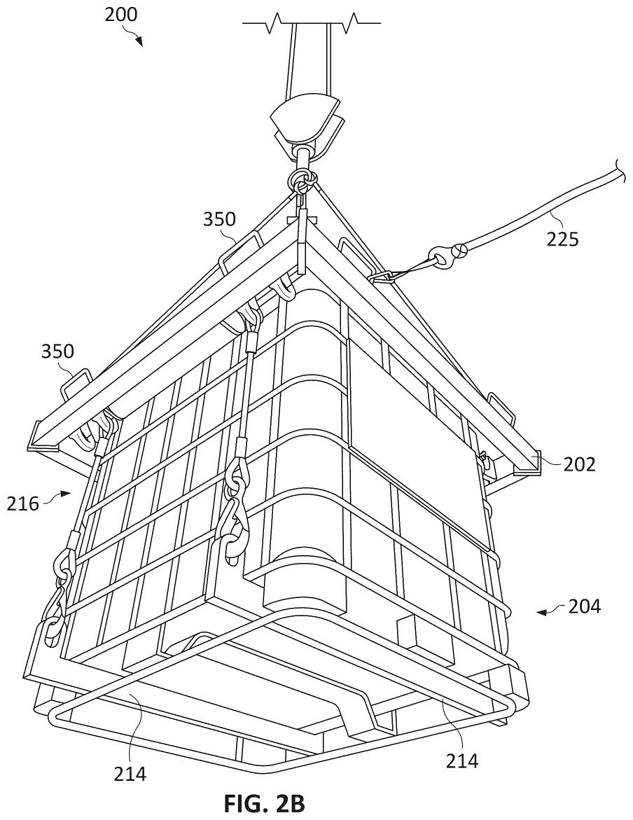

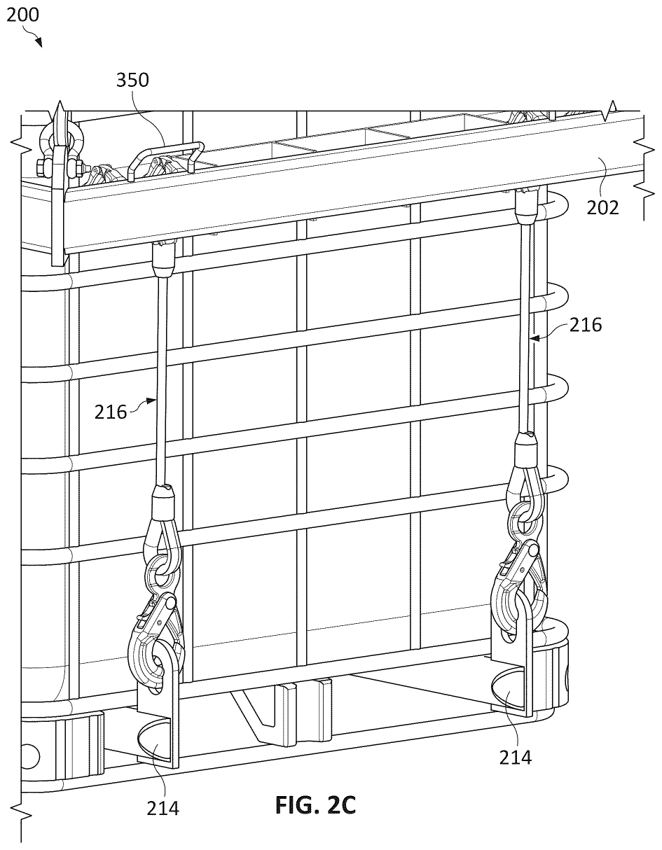

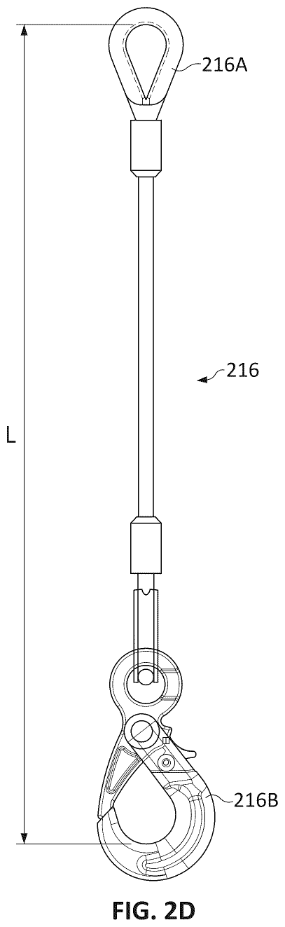

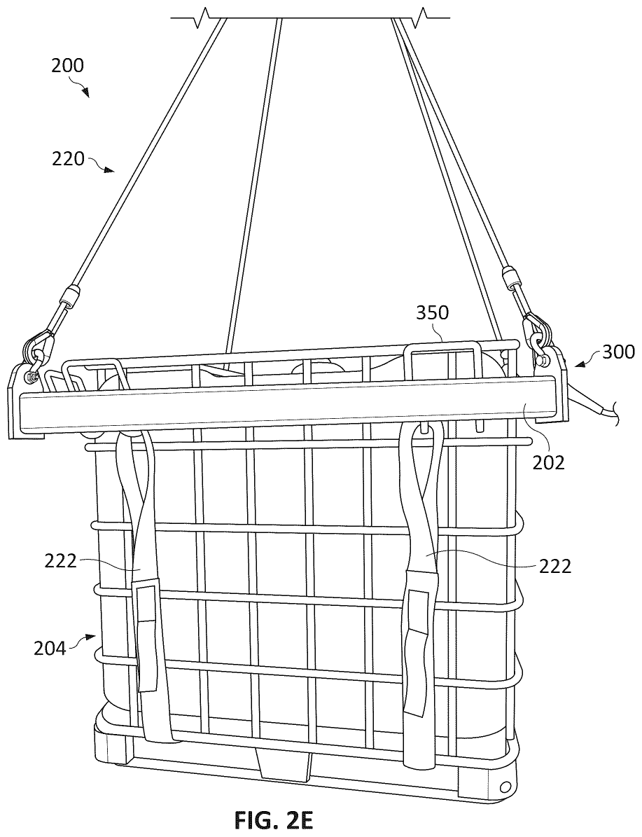

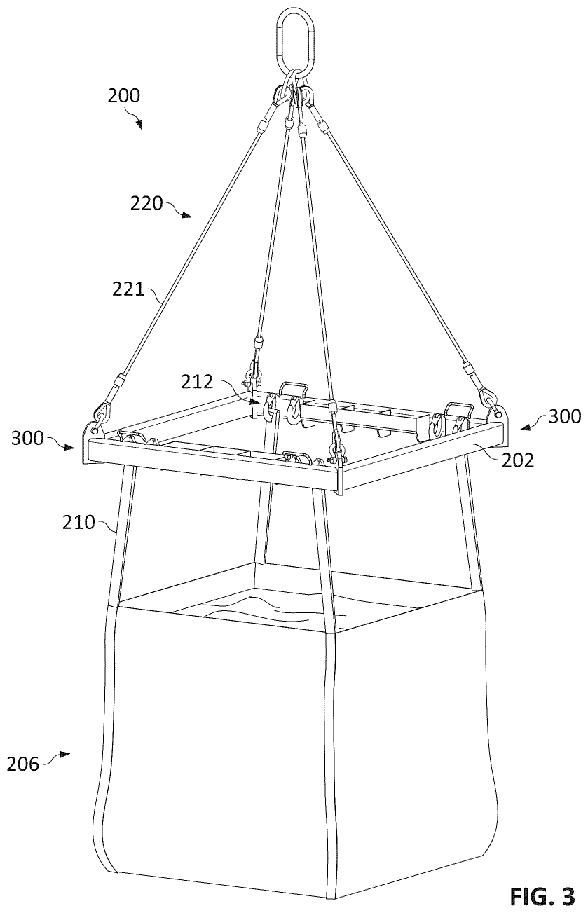

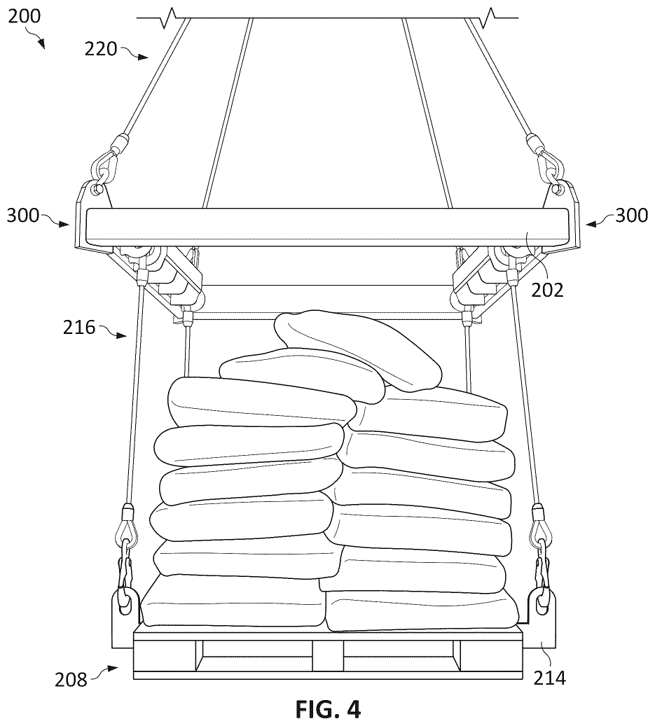

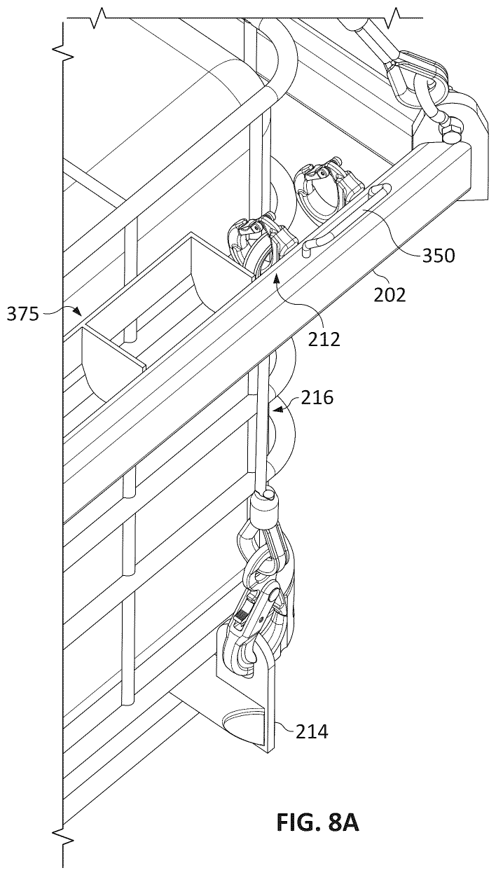

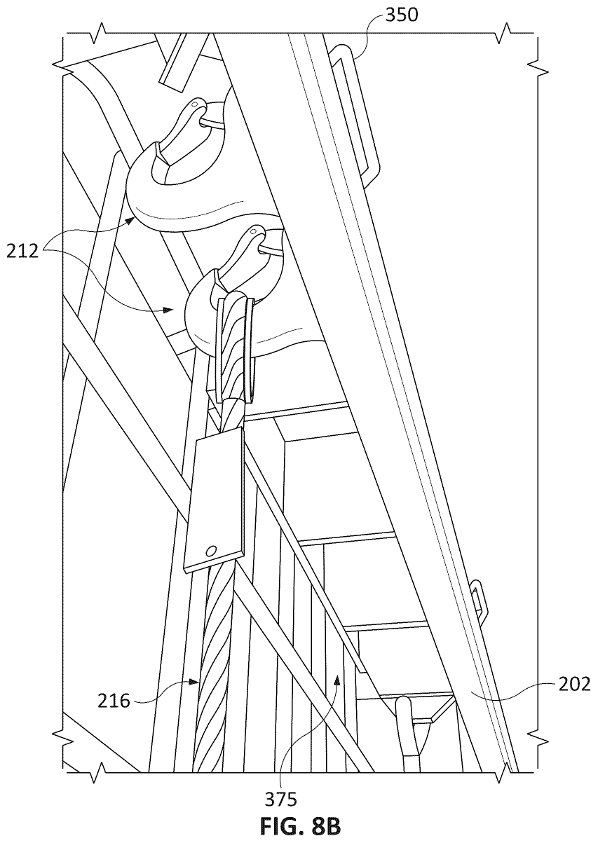

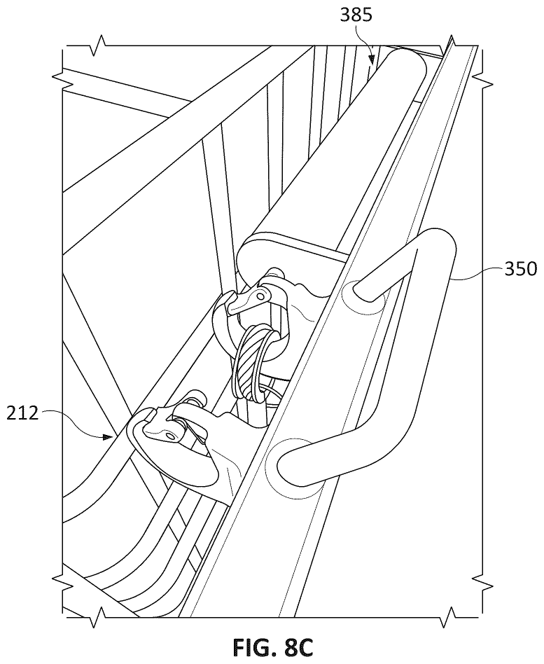

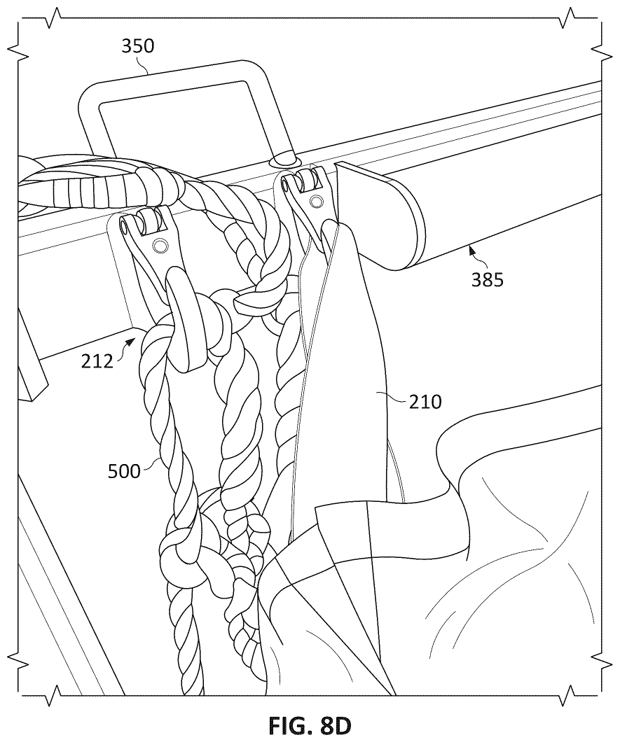

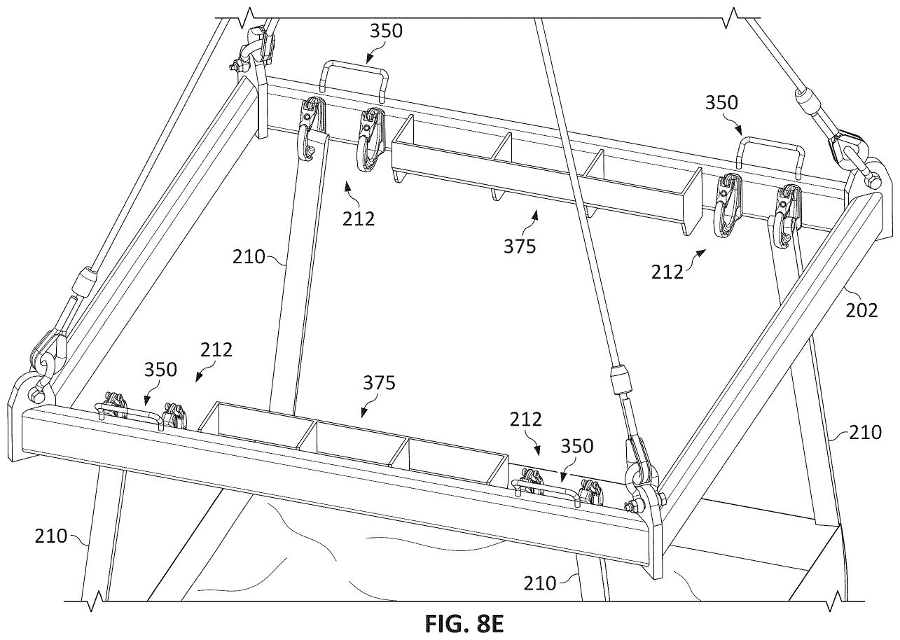

As an overview of the various modes of the disclosed offshore lifting system, reference is now made to FIGS. 2A-2E, 3, and 4. FIGS. 2A-2C and 2E illustrate various embodiments of an offshore lifting system 200 (or lifter 200) in an IBC mode (or IBC lifting mode) and configured to lift an IBC 204, FIG. 3 illustrates an embodiment of the lifter 200 in an FIBC mode (or FIBC lifting mode) and configured to lift an FIBC 206, and FIG. 4 illustrates an embodiment of the lifter 200 in a pallet mode (or pallet lifting mode) and configured to lift a pallet 208. As shown, the lifter 200 may include an upper lifting frame 202 from which the IBC 204, the FIBC 206, or the pallet 208 is suspended as a payload in respective ones of the lifting modes. For example, as shown in FIG. 3, FIBCs such as the FIBC 206 may be hung (or suspended) via their own integrated straps or handles (e.g., such as straps or handles 210 of the FIBC 206) from hooks 212 (which are illustrated in more detail in FIGS. 8A-8E) fix-welded to the upper lifting frame 202 adjacent to each corner of the upper lifting frame 202. In other examples, as shown in FIGS. 2A-2C and 4, IBCs such as the IBC 204 and pallets such as the pallet 208 may be elevated by (or supported by) lower lifting bars 214 (or pallet bars) which are substantially parallel to each other, and which pass through a pallet bottom (or forklift pockets) of the IBC 204 or the pallet 208.

In some cases, the lower lifting bars 214 used for each of the IBC 204 and the pallet 208 are the same. However, in some cases, the lower lifting bars 214 used for the pallet 208 may be longer to accommodate a larger pallet size (e.g., such as 48″×48″). In some examples, the longer lower lifting bars 214 may be referred to as pallet bars, while the shorter lower lifting bars 214 may be referred to as IBC bars. In some cases, the lower lifting bars 214 used in IBC mode may be as wide as the upper lifting frame 202. In various examples, the lower lifting bars 214 may be suspended by four (4) wire rope slings (or slings) 216 for even load distribution (two (2) slings per lifting bar 214) attached to lifting lugs at distal ends of the lower lifting bars 214, the slings 216 further coupled to the hooks 212 on the upper lifting frame 202. The slings 216 may, in some cases, help prevent the lower lifting bars 214 from getting hooked under adjacent loads or structures. FIG. 2C shows a more detailed view of a side portion of the lifter 200 in IBC mode, and including the slings 216 and the lower lifting bars 214. FIG. 2D provides a more detailed view of an exemplary sling 216, which may be configured as a thimble eye hook assembly. As shown, the sling 216 has a length ‘L’ and may include an upper end fitting 216A which couples to a hook 212 on the upper lifting frame 202, and a lower end fitting 216B (which may be a hook 216B) that couples to a lifting lug at a distal end of a lower lifting bar 214. In some embodiments, the slings 216 used in pallet mode may be the same (e.g., have substantially the same length ‘L’) as the slings 216 used in IBC mode. However, in other cases, the slings 216 used in pallet mode may be longer than the slings 216 used in IBC mode (e.g., to accommodate a larger pallet size). In addition, the length ‘L’ of the slings 216 used in the IBC mode may vary based on a size of the particular IBC tote used (e.g., 275 gallon, 330 gallon, etc.). For instance, in some cases, the differently sized IBC totes (e.g., 275 gallon and 330 gallon IBC totes) differ only in a dimension of their height. Thus, in some cases, the length ‘L’ of the sling 216 can be selected to accommodate a desired IBC tote size.

Generally, in IBC mode, an angle from vertical for the slings 216 used to suspend the pair of shorter lower lifting bars 214 (IBC bars) is equal to about 0 degrees. In some embodiments, in pallet mode using the shorter lower lifting bars 214 (IBC bars) and longer slings 216 (e.g., to lift 40″×48″ pallets), an angle from vertical for the slings 216 used to suspend the pair of IBC bars is equal to about 0 degrees. In other embodiments, in pallet mode using the longer lower lifting bars 214 (pallet bars) and longer slings 216 (e.g., to lift 48″×48″ pallets), an angle from vertical for the slings 216 used to suspend the pair of pallet bars is not equal to about 0 degrees (e.g., and may be greater than 0 degrees). In some examples, each of the IBC bars and pallet bars may be designed for at least about a 1.25 MT working load limit.

In some alternative examples, as shown in FIG. 2E, IBCs such as the IBC 204 may be elevated by (or supported by) polyester slings 222 (or ‘soft slings’ or ‘soft legs’) of appropriate capacity. In some embodiments, the polyester slings 222 may be configured in a basket configuration to provide cradle-like support of the IBC 204, where eyes of the polyester slings 222 are suspended from the hooks 212 that are fix-welded to the upper lifting frame 202, and where the polyester slings 222 run underneath the IBC 204, passing through the forklift pockets of the IBC 204. While other embodiments are possible, in at least some cases, the polyester slings 222 may have a 3″ width, a 3-ply thickness, and may be fitted with an abrasion-resistant sleeve. In the basket configuration, the polyester slings 222 may provide a capacity of greater than about 12,000 lbs (e.g., such as about 12,300 lbs, in some examples). In various examples, lifting IBCs using polyester slings (e.g., such as the polyester slings 222) may be particularly useful when a frame of an IBC totes is damaged and pallet bars will not fit into the forklift pockets. Such a situation is frequently encountered in an offshore environment, making the option of using polyester slings all the more useful. In another example, polyester slings may be useful when IBC totes are positioned in containers or tight spaces where access is limited and the use of pallet bars is not possible or practical.

By way of example, use of the hooks 212 also provides for easy-on/easy-off attachment of the handles 210, the slings 216, or the polyester slings 222, for case of switching among the IBC mode, FIBC mode, and the pallet mode and for ease of switching among various other lifting configurations (e.g., pallet bars or polyester slings, slings of different length, etc.). In addition, in each of the three modes (e.g., IBC mode, FIBC mode, and pallet mode) and as described in more detail below, the lifter 200 and payload (e.g., such as the IBC 204, FIBC 206, or pallet 208) may be lifted and transported using an upper sling set 220 attached at the corners of the upper lifting frame 202, and the upper sling set 220 may further be coupled to a crane, hoist, or other lifting machine. In at least some cases, and as shown in the example of FIG. 2B, a rigid push/pull stick or tagline 225 may also be coupled to the lifter 200 (e.g., such as to a handle 350 coupled to a top surface of the upper lifting frame 202), to enable hands-free manipulation of the load.

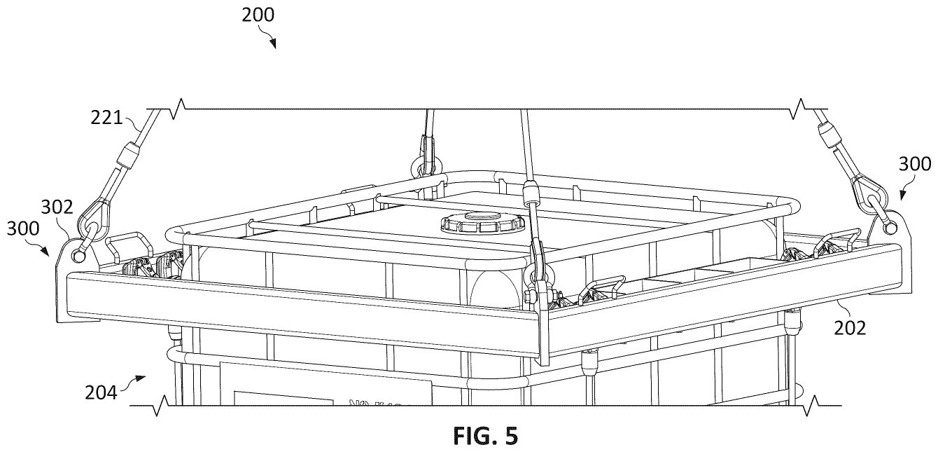

During operation, the lifter 200 is configured such that the upper lifting frame 202 may be brought into position and lowered down over the payload (e.g., such as the IBC 204, FIBC 206, or pallet 208) in order to secure the payload to the lifter 200 (e.g., such as by using lower lifting bars 214 and slings 216, polyester slings 222, or integrated straps or handles 210, as discussed above). In various embodiments, securing of the payload to the lifter 200 may be accomplished without setting the upper lifting frame 202 down (e.g., onto the ground) or onto the payload itself. As a result, when securing the payload to the lifter 200, the upper sling set 220 will not go slack. Thus, there is substantially no opportunity for the upper sling set 220 to go slack immediately preceding a lifting operation. As an illustrative example and with reference to FIG. 5, which shows a portion of the lifter 200 configured in IBC mode (e.g., where the payload includes an IBC such as the IBC 204), the upper lifting frame 202 fully circumscribes, encapsulates, or surrounds an upper portion of the IBC 204, when brought into position and lowered over the payload, such that the upper lifting frame 202 fully laterally contains (e.g., providing 360-degree containment) the payload and protects against lateral forces (e.g., such as lateral forces caused by fluids sloshing within the IBC 204, and which could otherwise cause the IBC 204 to overturn). Stated another way, an upper surface of the IBC 204 may extend above an upper surface of the upper lifting frame 202 (or in some cases may at least be substantially level with the upper surface of the upper lifting frame 202), thereby ensuring full load containment by the upper lifting frame 202. In a related, but more general example, a region of the lifter 200 within which the payload (e.g., such as an IBC, FIBC, or palleted load) is received (e.g., including the region circumscribed by the upper lifting frame 202 and the region over which the upper lifting frame 202 is brought into position and lowered down over), may be referred to as a payload region. Thus, regardless of the type of payload, the upper lifting frame 202 may be said to fully circumscribe, encapsulate, or surround the payload region. In some cases, the upper lifting frame 202 may be said to fully circumscribe, encapsulate, or surround the payload region at least from a top-down view of the lifter 200.

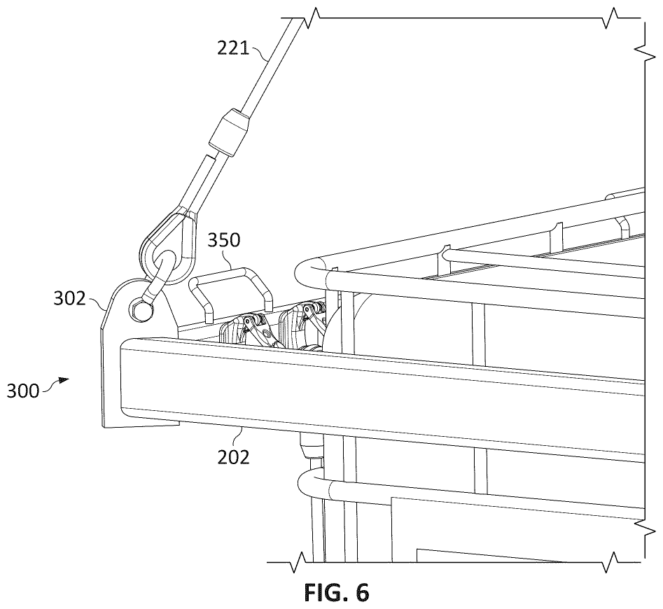

As shown in the figures, and in various embodiments, the upper lifting frame 202 has a substantially square shape (e.g., from a top view) with lifting points 300 disposed at each corner of the upper lifting frame 202. Thus, the upper lifting frame 202 may optionally be referred to as a rectilinear frame assembly, a rectilinear lifting frame, or an upper lifting frame having a rectilinear shape. In an example, the lifting points 300 disposed at each corner of the upper lifting frame 202 may include plates with a radiused (or rounded) upper portion including a radiused lifting lug or padeye 302 (e.g., as shown in more detail in FIG. 6, which shows a corner region of the upper lifting frame 202 while the lifter 200 is in the IBC mode). In some embodiments, each sling 221 of the upper sling set 220 couples to a respective corner of the upper lifting frame 202 (e.g., by way of an end fitting of the sling coupled to a shackle attached to the radiused lifting lug or padeye 302). In some cases, a corner of the lifter 200 could potentially swing underneath an overhanging adjacent structure (e.g., such as during a lifting operation). The angle of the lifting slings 221 (e.g., of the upper sling set 220) and the radiused lifting lug or padeye 302 should help to guide the lifter 200 out from underneath the overhanging adjacent structure (e.g., for example, if the force driving the lifter 200 underneath the overhanging adjacent structure is not extremely large). In addition, because of the positioning of the radiused lifting lug or padeye 302 (e.g., as shown in FIG. 6) on the upper lifting frame 202, the four slings 221 of the upper sling set 220 will not come into contact with the IBC tote.

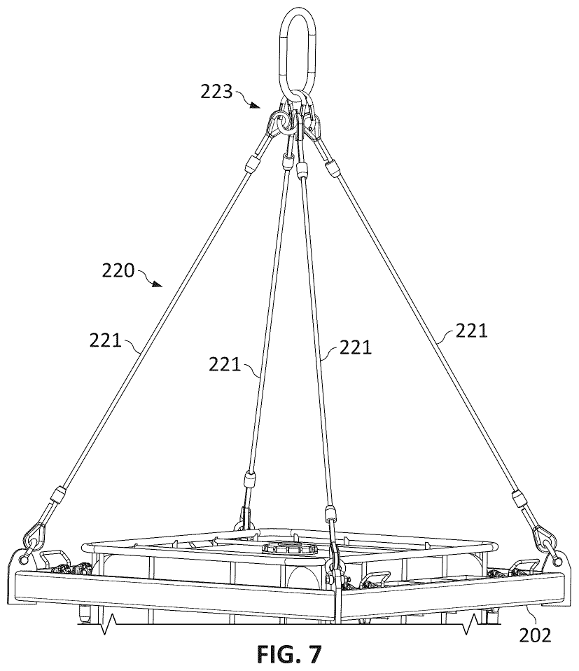

Elaborating on the upper sling set 220, and with reference to FIG. 7 (e.g., which shows a portion of the lifter 200 including the upper lifting frame 202 coupled to the upper sling set 220), the upper sling set 220 may be designed as a symmetric matched pair (e.g., including four identical slings 221 of equal length, with two slings per sub link of a master link assembly 223). The upper sling set 220 may thus be equivalently referred to as a 4-leg sling with a master link assembly. In various embodiments, the upper sling set 220 is designed with a nominal 30° angle from vertical for each leg (e.g., for each of the four identical slings 221). Stated another way, the upper sling set 220 is configured to provide at least a 60° angle from horizontal for each leg (e.g., for each of the four identical slings 221). In various embodiments, the IBCs, FIBCs, or palleted loads may be lifted, for example, by a crane, hoist, or other lifting machine coupled to the master link assembly 223.

As noted above, the hooks 212 provide for easy-on/easy-off attachment of the handles 210, the slings 216, or the polyester slings 222, for easy switching among lifting modes and for easy switching among different lifting configurations. In furtherance of that discussion, reference is made to FIGS. 8A-8E, which provide various views of the lifter 200, and in particular, which provide various views of interior portions of the upper lifting frame 202 that illustrate further details about the hooks 212, as well as other features of the lifter 200. In various examples, the hooks 212 (e.g., used for suspending the payload) face inwards along interior surfaces of the upper lifting frame 202 and thereby avoid (or are protected from) damage, snagging, or otherwise getting hung up on adjacent loads or structures. To further protect the hooks 212, and to provide further containment of the payload, bumpers (e.g., such as bumpers 375 shown in FIGS. 8A, 8B, and 8E, or such as bumpers 385 shown in FIGS. 8C and 8D) may also be attached to opposing interior surfaces of the upper lifting frame 202 between sets of hooks 212. For instance, each bumper 375 or bumper 385 may be attached along a given interior surface of the upper lifting frame 202 between respective sets of inward facing hooks 212 that are also attached to the given interior surface, but which are disposed at lateral ends of the given interior surface, adjacent to respective corners of the upper lifting frame 202 and on either side of the bumper 375 or the bumper 385. In some cases, the bumpers 375, 385 may also extend further than the hooks 212, from the given interior surface of the upper lifting frame 202, in order to effectively protect the hooks 212. In the embodiments shown, bumpers 375 include flat standoffs and bumpers 385 include a cylindrical pipe that provides a radiused surface. While not limited to a particular type of bumper, in at least some embodiments, the bumpers 385 with the radiused surface may be used to allow for the upper lifting frame 202 to more easily be lowered down/lifted up over an IBC tote while not catching onto or snagging on the upper lifting frame 202. In some embodiments, bumpers 375, 385 may also provide a safe place for personnel to place their hands during installation of the handles 210, slings 216, or polyester slings 222 into the hooks 212.

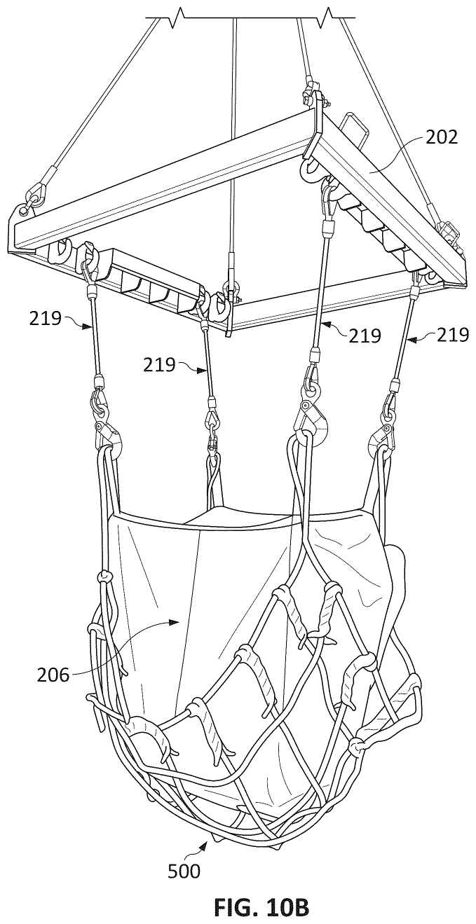

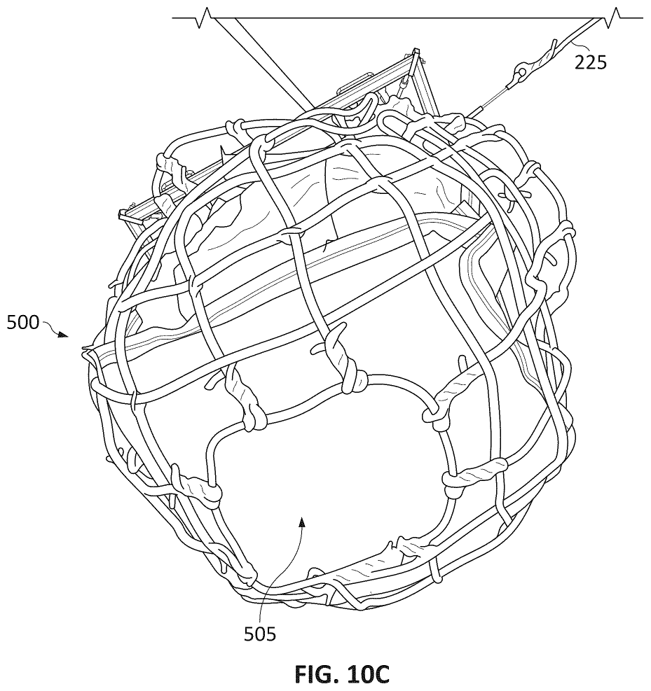

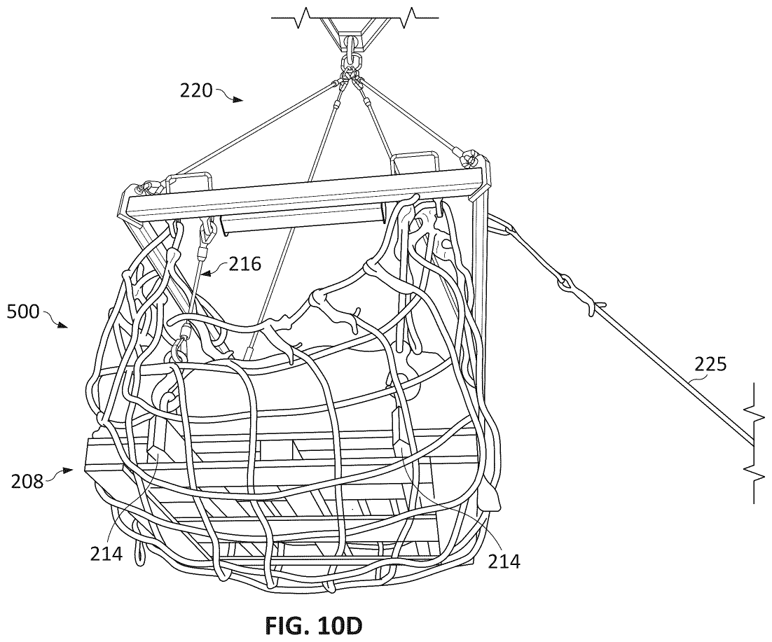

With respect to the various views of the lifter 200 of FIGS. 8A-8E, FIGS. 8A-8C illustrate the lifter 200 in the IBC mode, and FIGS. 8D and 8E illustrate the lifter 200 in the FIBC mode. In particular, with reference to FIG. 8E, the inward facing hooks 212 are utilized to suspend the payload. In various examples, FIBCs include dedicated lifting straps or handles 210 with a looped eye that affixes respective ones of the hooks 212 on the upper lifting frame 202. In all modes (e.g., IBC mode, FIBC mode, and pallet mode), the upper lifting frame 202 may be equipped with eight (8) inward facing hooks 212 (e.g., such as weld-on excavator hooks). In some embodiments, the inward facing hooks 212 may have a capacity of at least about 3 MT, to provide a large safety factor. In FIBC mode, in particular, the positioning of the inward facing hooks 212 is configured to facilitate, and provide a best handle positioning, of various sizes of FIBCs that are currently available in the market. In this respect, the lifter 200 provides two (2) hook configurations at each corner of the upper lifting frame 202, for example, provided by a pair of inward facing hooks 212 attached adjacent to each corner of the upper lifting frame 202 and along opposing interior surfaces of the upper lifting frame 202. In various embodiments, the two hook configurations enable the FIBC to be hung, by appropriate hook selection between the two inward facing hooks 212 adjacent to each corner of the upper lifting frame 202, in a manner that: (1) does not put excessive stress on the lifting handles 210; and (2) ensures that the hooks 212 on the upper lifting frame 202 do not experience a load at an angle that exceeds a manufacturers recommended criteria. Stated another way, the hook selection includes selection between a wider or outer set of hooks 212 (spaced further apart along a given surface of the upper lifting frame 202) and a narrow or inner set of hooks 212 (spaced more closely along the given surface of the upper lifting frame 202). In the example of FIG. 8D, which illustrates a corner region of the upper lifting frame 202, an FIBC handle 210 is coupled to one hook 212 of the two hook configuration, and a cargo net 500 is coupled to the other hook 212 of the two hook configuration, the cargo net 500 used to surround the FIBC and provide for dropped object protection. The example of FIG. 8D is discussed in more detail below with reference to FIG. 10A.

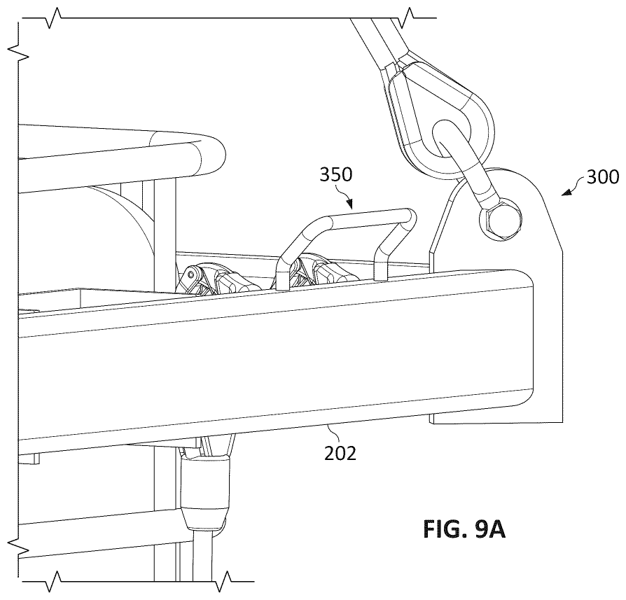

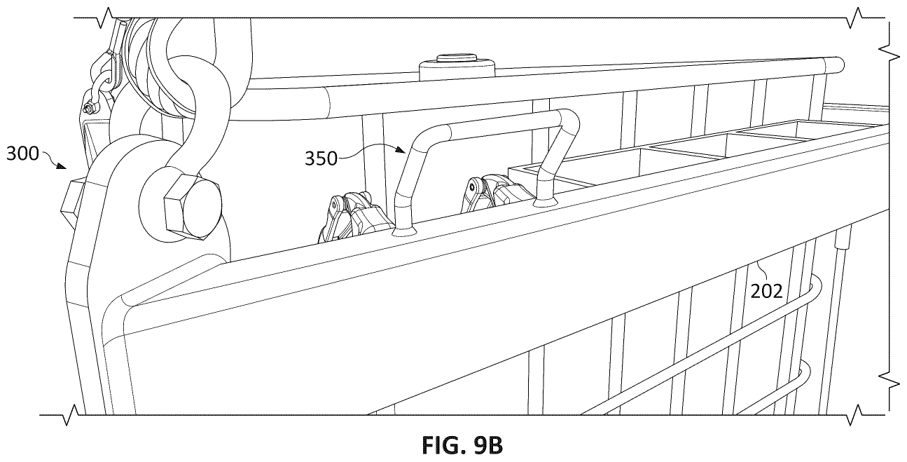

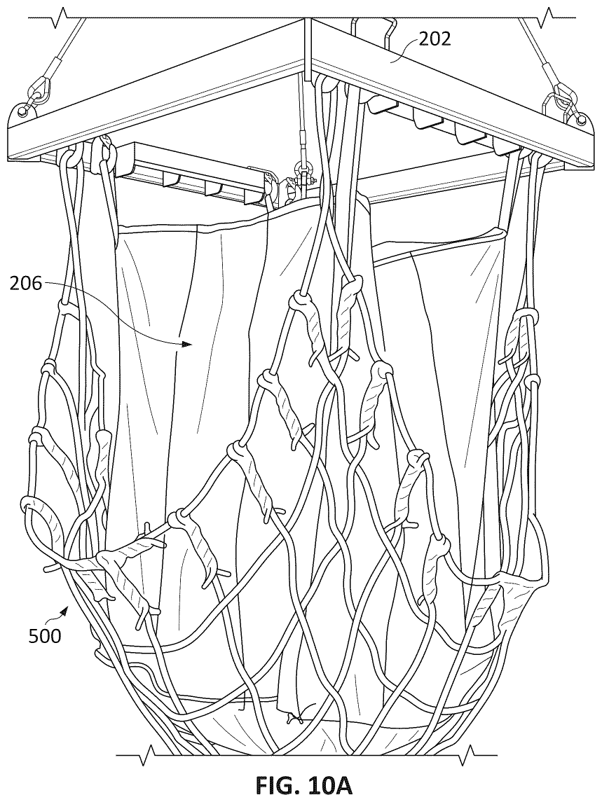

As previously described, a rigid push/pull stick or tagline 225 may be coupled to the lifter 200 to provide for hands-free manipulation of the load. However, in some cases, final manipulation and positioning of some loads, especially when the load is being rigged up, may require personnel to physically touch the lifter 200 and/or load to maneuver it into place. Thus, in all modes (e.g., IBC mode, FIBC mode, and pallet mode), the upper lifting frame 202 may include one or more handles 350 coupled to a top surface of the upper lifting frame 202 (e.g., such as shown in the examples of FIGS. 2A-2C, 2E, 6, 8A-8E, 9A, and 9B). In some cases, the upper lifting frame 202 includes eight (8) handles 350 coupled to the top surface of the upper lifting frame 202 (e.g., such as two per side of the rectilinear frame assembly). In an example, the handles 350 may include “green” colored handles for quick identification and safe hand positioning. Stated another way, the handles 350 provide a safe place for a person to touch, grasp, or otherwise manipulate the lifter 200 without risk of a pinching injury.

Referring now to FIG. 10A, and in some embodiments, the upper lifting frame 202 is designed to enable a cargo net 500 to be hung from the inward facing hooks 212. In one example, in FIBC mode, an FIBC handle 210 is attached to a first one of the pair of hooks 212 adjacent to a given corner of the upper lifting frame 202, and a first cargo net attachment point (e.g., such as a loop at a corner of the cargo net 500) is attached to a second one of the pair of hooks 212 adjacent to the given corner of the upper lifting frame 202. The remaining FIBC handles 210 and cargo net attachment points may be similarly attached to the pairs of hooks 212 adjacent to the other corners of the upper lifting frame 202. As a result, the cargo net 500 serves to surround and contain the FIBC 206 during lifting and transport, thereby providing additional load containment and dropped object protection during transport of the FIBC 206. For instance, if a handle 210 of the FIBC 206 breaks during transport, the FIBC 206 will slough into the cargo net 500, thereby mitigating the risk of the FIBC 206 being dropped from a height.

In the example of FIG. 10A (and FIG. 8D), the FIBC 206 and the cargo net 500 are affixed directly to the hooks 212. However, with reference to FIG. 10B, spacer slings 219 (also referred to as supplemental slings, which may be similar to the slings 216, discussed above) may be used as an intermediary coupling between the FIBC 206/cargo net 500 and the upper lifting frame 202. A spacer sling 219, configured as a thimble eye hook assembly, may include an upper end fitting that couples to a hook 212 at a given corner of the upper lifting frame 202, and a lower end fitting (which may include a hook) that couples to both an FIBC handle 210 and a first cargo net attachment point. The remaining FIBC handles 210 and cargo net attachment points may be similarly attached to the other corners of the upper lifting frame 202 by way of other spacer slings 219. As a result, the cargo net 500 once again serves to surround and contain the FIBC 206 during lifting and transport, thereby providing additional load containment and dropped object protection during transport of the FIBC 206. In addition, however, by using the spacer slings 219, the upper lifting frame 202 is raised a distance above the load, the distance equal to or greater than a length of the spacer slings 219. The slings 216, discussed above, may be used as the spacer slings 219, in some cases. Thus, the length of the spacer slings 219 may be the length ‘L’ of the slings 216, which may also vary depending on the particular application, as discussed above. By raising the upper lifting frame 202 the distance above the load, the lifter 200 is able to accommodate oddly shaped bag sizes and minimize outward pulling forces on the FIBC handles 210. Generally, to ensure safe handling of the FIBC 206, the angle of “outward” pull on the FIBC straps or handles 210 should be minimized. “Inward” pull is not typically a concern for FIBC handling. As noted above, the lifter 200 provides two (2) hook configurations at each corner of the upper lifting frame 202, for example, provided by a pair of inward facing hooks 212 attached adjacent to each corner of the upper lifting frame 202 and along opposing interior surfaces of the upper lifting frame 202. In particular, the two (2) sets of hooks 212 provided in the upper lifting frame 202 include one (1) wide set of hooks 212 and one (1) narrow set of hooks 212 along a given interior surface of the upper lifting frame 202. In some embodiments, the more narrowly spaced hooks 212 may be used for smaller bags (smaller FIBCs), and the more widely spaced hooks 212 may be used for larger bags (larger FIBCs). In some embodiments, a lifting leg length may be defined as a combined length of the FIBC strap or handle 210 and the spacer sling 219. In various embodiments, the lifting leg length should be long enough to ensure that “outward” pull loading angles do not exceed 10°.

In some use cases, and while the lifter 200 is in FIBC mode, an FIBC 206 may be positioned and lowered onto a mixing hopper that is configured to receive the contents of the FIBC 206 for subsequent processing. To provide dropped object protection while lowering the FIBC 206 onto the mixing hopper, and while emptying the contents of the FIBC 206, it may be useful to provide an alternative embodiment of the cargo net 500. For instance, referring to FIG. 10C, illustrated therein is an example of using the lifter 200 in FIBC mode with another embodiment of the cargo net 500. In particular, the example of FIG. 10C provides a bottom view of the lifter 200, and thus a bottom view of the cargo net 500. As shown, in this example, the cargo net 500 may include an opening 505 aligned with a bottom portion of the FIBC 206. In some embodiments, the opening 505 includes a generally square opening, although other shape openings may equally be used (e.g., circular, rectangular, etc.). The opening 505 may generally be formed in a variety of shapes and sizes, but in at least some examples, the opening 505 may include a square opening have sides with a length of about 18 inches. More particularly, the opening 505 may be sized to provide access to slitters to cut open the FIBC 206 without damaging the cargo net 500, while also sized to ensure that the cargo net 500 remains on the FIBC 206, both when the FIBC 206 is lowered onto the mixing hopper and while its contents are emptied.

While use of the cargo net 500 has been shown and described above with reference to use while the lifter 200 is in FIBC mode, it will be understood that the cargo net 500 may be similarly employed in while the lifter 200 is in IBC mode or pallet mode, to provide additional load containment and/or dropped object protection during transport of an IBC tote or palleted load. For example, with reference to FIG. 10D, illustrated therein is an example of using the lifter 200 in pallet mode with the cargo net 500. In some embodiments, a first sling 216, which is attached to a lifting lug at a first distal end of a first lower lifting bar 214, is also attached to a first one of the pair of hooks 212 adjacent to a given corner of the upper lifting frame 202, and a first cargo net attachment point (e.g., such as a loop at a corner of the cargo net 500) is attached to a second one of the pair of hooks 212 adjacent to the given corner of the upper lifting frame 202. The remaining slings 216 and cargo net attachment points may be similarly attached to the lower lifting bars 214 and to the pairs of hooks 212 adjacent to the other corners of the upper lifting frame 202. As a result, the cargo net 500 serves to surround and contain the palleted load during lifting and transport, thereby providing additional load containment and dropped object protection during transport of the pallet 208 and any additional load disposed thereon. In like manner, the cargo net 500 may be employed with the lifter 200 in IBC mode. It is also noted that cargo nets 500 of different sizes may be used, in various embodiments, in order to provide a best match for variously sized FIBCs available in the market, as well as to accommodate the different payload sizes of IBCs or palleted loads.

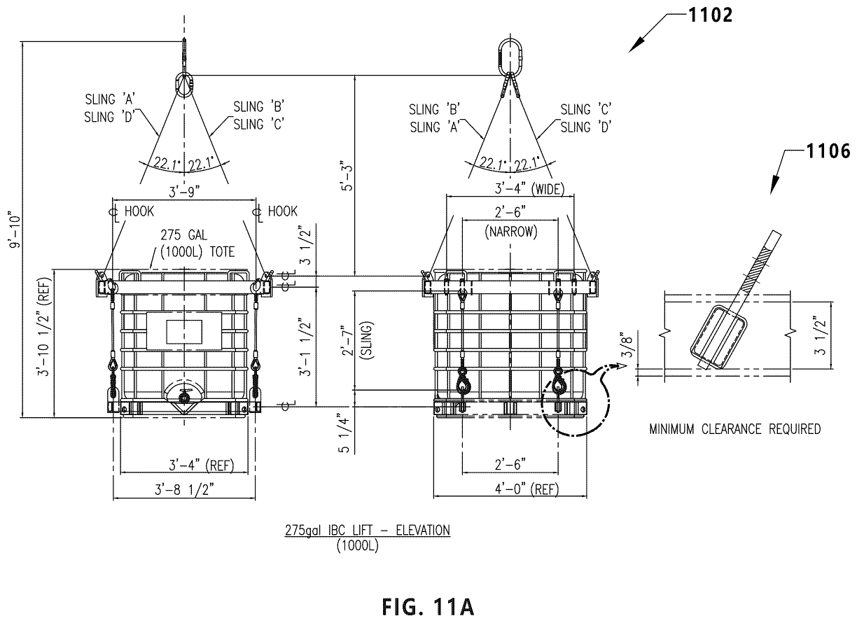

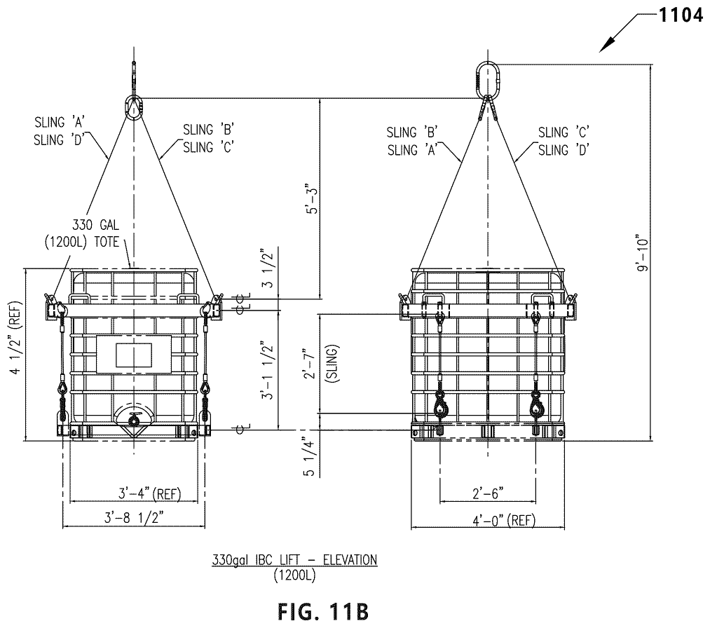

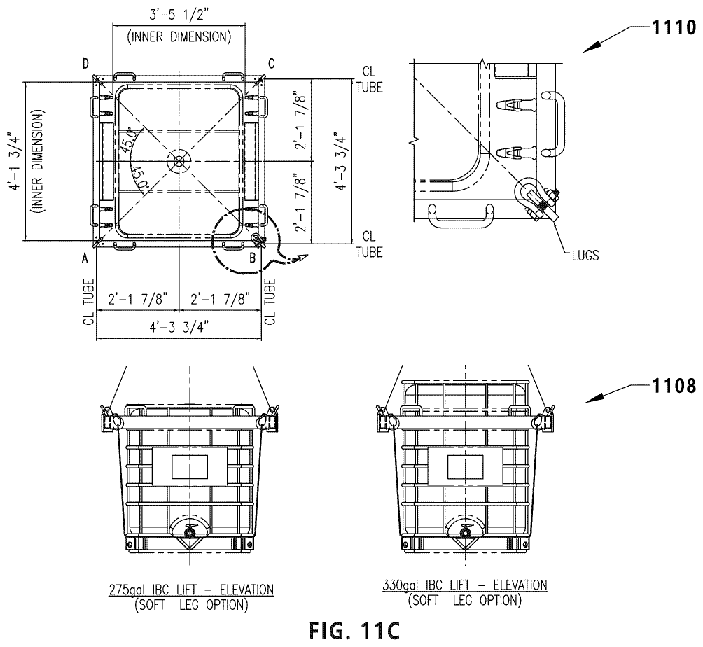

Referring now to FIGS. 11-15, illustrated therein are general arrangement views for the disclosed lifter 200 in each of the various modes (e.g., IBC mode, FIBC mode, pallet mode), and in various configurations (e.g., pallet bars or polyester slings, etc.). FIG. 11 provides elevation, top-down, and end views of an exemplary lifter, or portions thereof, in IBC mode. Elevation views 1102 illustrate an example of using lower lifting bars and slings (e.g., such as the lower lifting bars 214 and slings 216, described above) for a 275 gallon IBC tote. Elevation views 1104 illustrate an example of using lower lifting bars and slings (e.g., such as the lower lifting bars 214 and slings 216, described above) for a 330 gallon IBC tote. End view 1106 illustrates an end view of a lower lifting bar such as the lower lifting bars 214. Elevation views 1108 illustrate an example of using polyester slings (e.g., such as the polyester slings 222, described above) in a basket configuration to provide cradle-like support for a 275 gallon IBC tote and for a 330 gallon IBC tote. Top-down views 1110 of the lifter provide more detailed views of the hooks (e.g., such as the hooks 212), handles (e.g., such as the handles 350), and shackles attached to the radiused lifting lug or padeye (e.g., such as the radiused lifting lug or padeye 302). It is noted that in the example of FIG. 11, the slings (e.g., slings 216 or polyester slings 222) may be coupled to the set of more narrowly spaced hooks (e.g., such as the hooks 212).

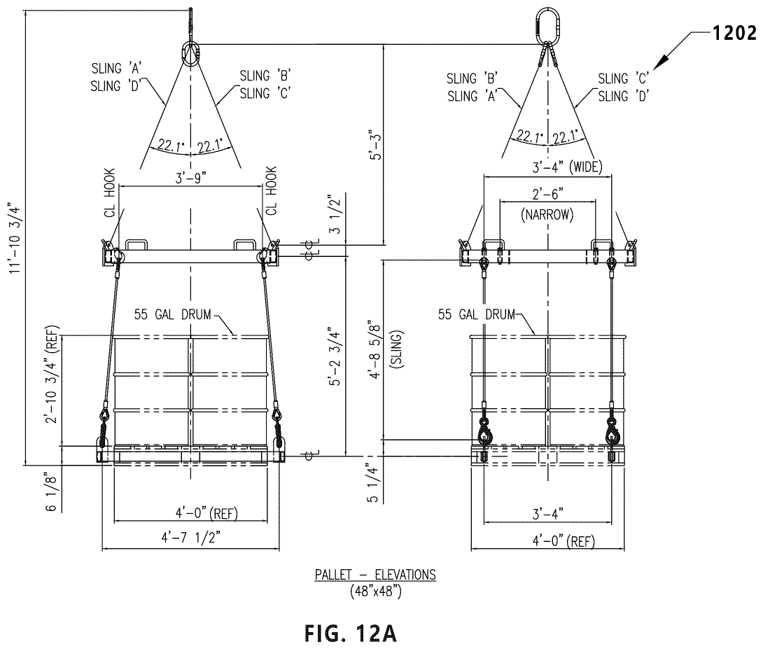

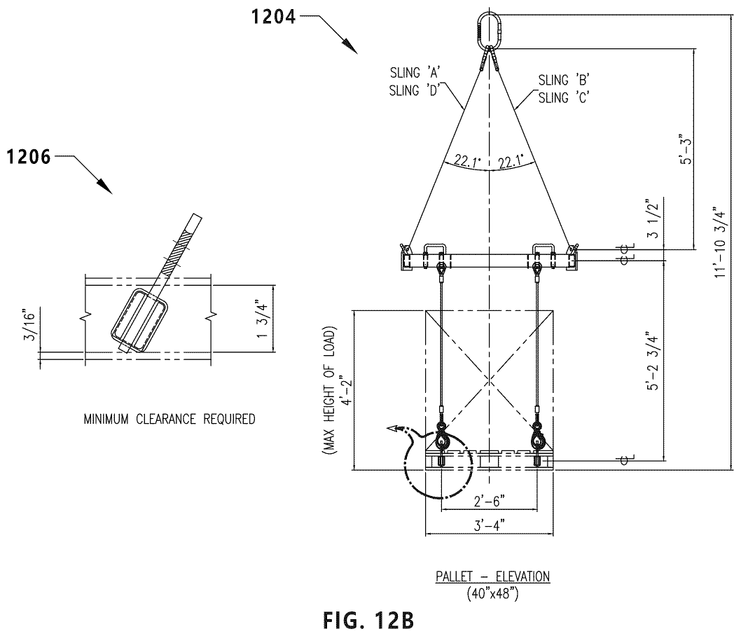

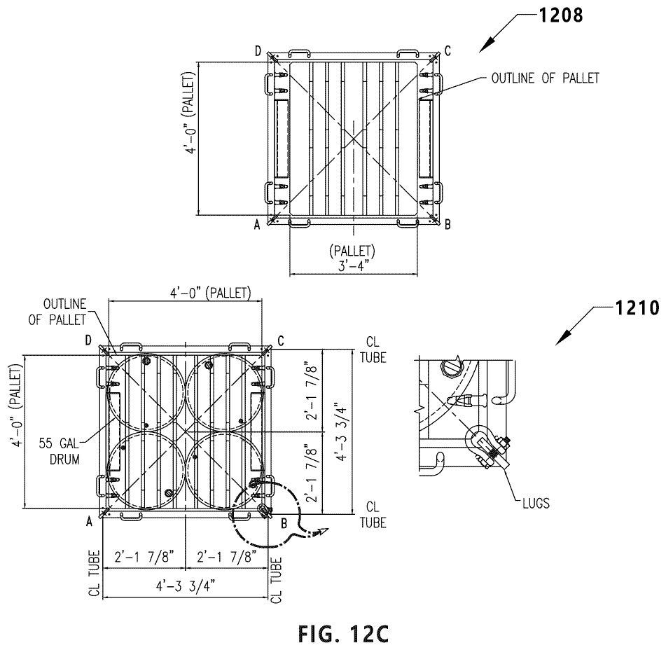

FIG. 12 provides elevation, top-down, and end views of an exemplary lifter, or portions thereof, in pallet mode. Elevation views 1202 illustrate an example of using lower lifting bars and slings (e.g., such as the lower lifting bars 214 and slings 216, described above), the slings coupled to the set of more widely spaced hooks, for lifting a 48″×48″ pallet. Elevation views 1204 illustrate an example of using lower lifting bars and slings (e.g., such as the lower lifting bars 214 and slings 216, described above), the slings coupled to the set of more narrowly spaced hooks, for lifting a 40″×48″ pallet. End view 1206 illustrates an end view of a lower lifting bar such as the lower lifting bars 214. As noted above, the lower lifting bars used to lift the 48″×48″ pallet may be longer than the lower lifting bars used to lift the 40″×48″ pallet. Top-down views 1208, 1210 of the lifter provide more detailed views of the hooks (e.g., such as the hooks 212), handles (e.g., such as the handles 350), and shackles attached to the radiused lifting lug or padeye (e.g., such as the radiused lifting lug or padeye 302). Top-down view 1208 corresponds to the elevation view 1204, for lifting a 40″×48″ pallet, and top-down view 1210 corresponds to the elevation view 1202, for lifting a 48″×48″ pallet.

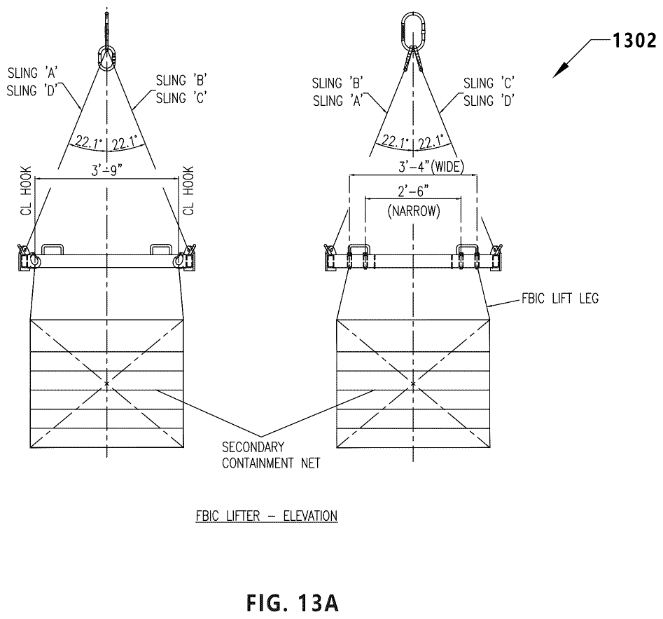

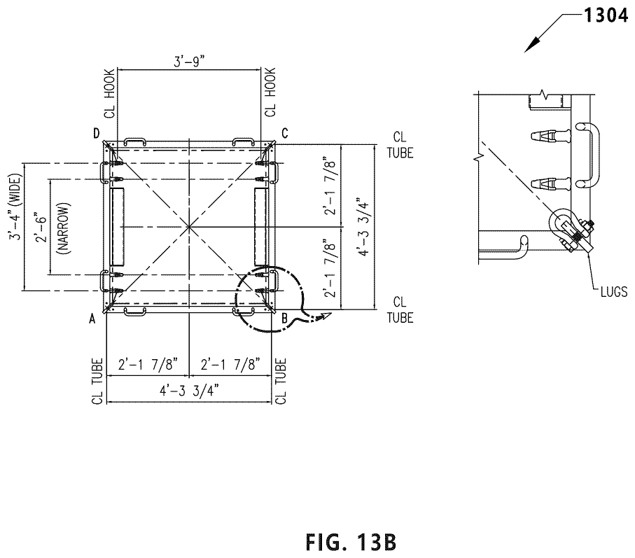

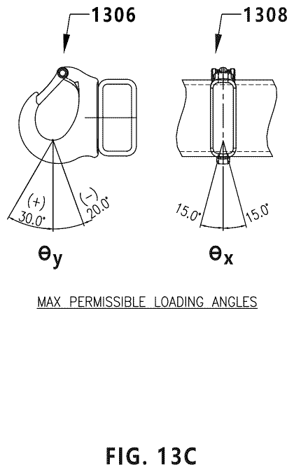

FIG. 13 provides elevation, top-down, side and end views of an exemplary lifter, or portions thereof, in FIBC mode. Elevation views 1302 illustrate an example of using the FIBC straps or handles (e.g., such as the straps or handles 210, described above) to suspend an FIBC directly from hooks (e.g., such as the hooks 212) on the upper lifting frame (e.g., such as the upper lifting frame 202). Top-down view 1304 of the lifter provides a more detailed view of the hooks (e.g., such as the hooks 212), handles (e.g., such as the handles 350), and shackles attached to the radiused lifting lug or padeye (e.g., such as the radiused lifting lug or padeye 302). Side view 1306 and end view 1308 provide side and end views, respectively, of a hook (e.g., such as the hook 212) and illustrate maximum permissible loading angles (e.g., of an FIBC handle suspended therefrom), in accordance with some embodiments. As shown, the maximum permissible loading angle from the side view 1306 is labeled as θy, and is in a range of between about +30 degrees from vertical and −20 degrees from vertical, and the maximum permissible loading angle from the end view 1308 is labeled as θx, and is in a range of between about +15 degrees from vertical and −15 degrees from vertical.

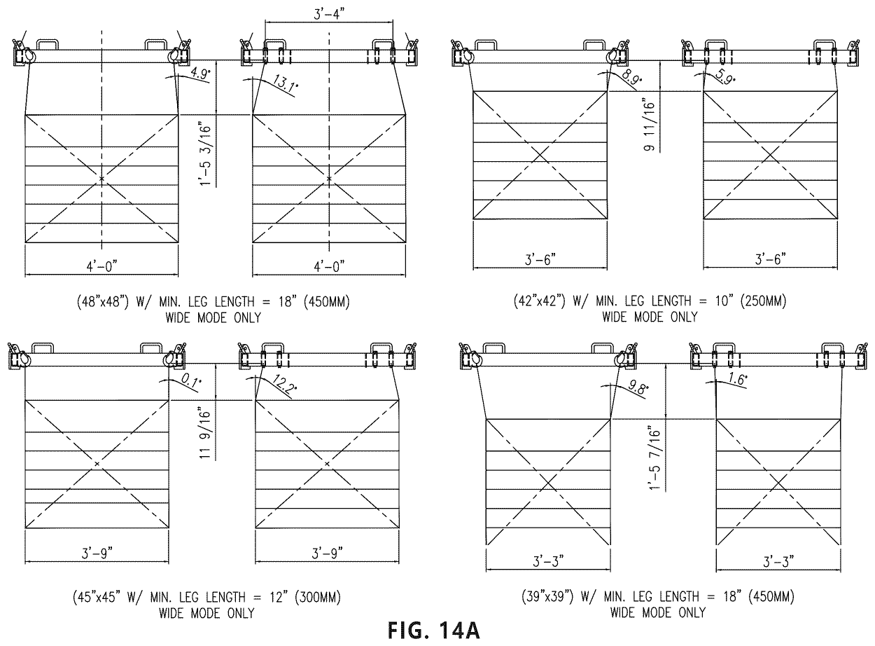

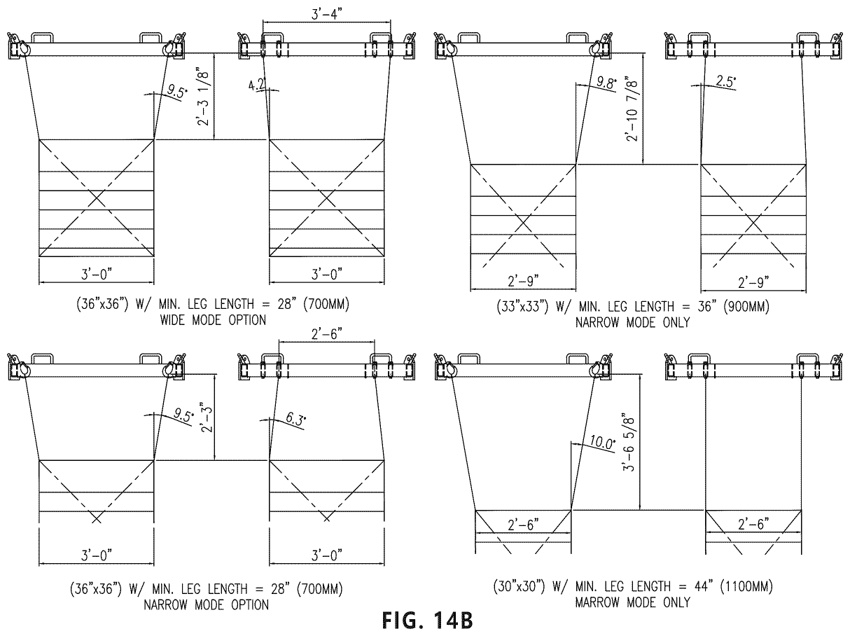

FIG. 14 provides elevation views of an exemplary lifter, or portions thereof, in FIBC mode and in accordance with various FIBC hanging arrangements or lifting leg configurations for FIBCs of various sizes (e.g., having a footprint or base dimensions in a range of from about 30″×30″ to about 48″×48″). In the exemplary configurations shown, for a 48″×48″, 45″×45″, 42″×42″, or a 39″×39″ FIBC size, the FIBC straps or handles (e.g., such as the straps or handles 210) may be coupled to the set of more widely spaced hooks (e.g., such as the hooks 212), each of the differently sized FIBCs resulting in varying loading angles (e.g., of an FIBC handle suspended therefrom). For a 36″×36″ FIBC size, the FIBC straps or handles may be coupled either to the set of more widely spaced hooks or to the set of more narrowly spaced hooks, resulting in varying loading angles. For a 33″×33″ or a 30″×30″ FIBC size, the FIBC straps or handles (e.g., such as the straps or handles 210) may be coupled to the set of more narrowly spaced hooks, each of the differently sized FIBCs resulting in varying loading angles.

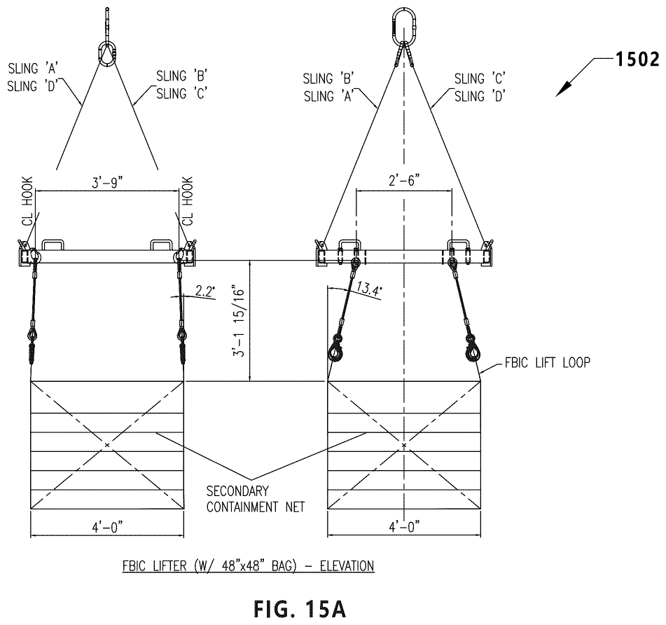

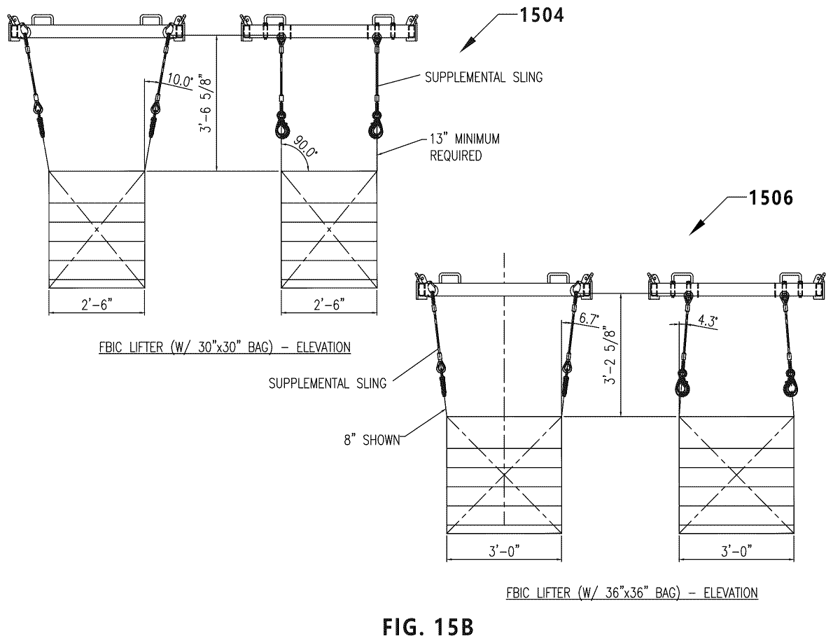

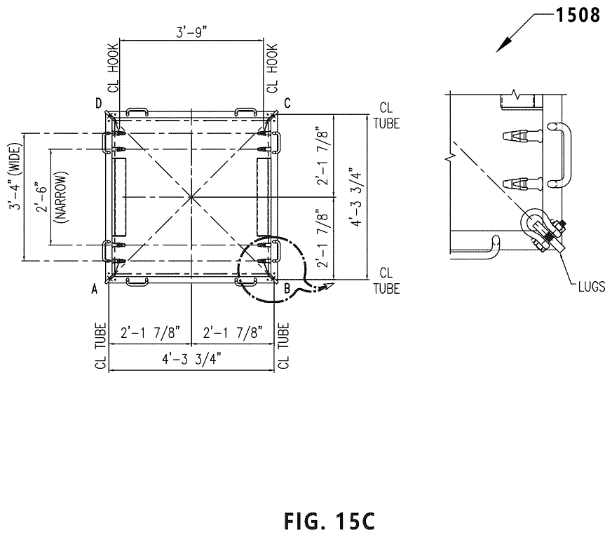

FIG. 15 provides elevation and top-down views of an exemplary lifter, or portions thereof, in FIBC mode and employing spacer slings (or supplemental slings). Elevation views 1502 illustrate an example of using straps or handles (e.g., such as the straps or handles 210, described above) of an FIBC (e.g., such as a 48″×48″ FIBC, in this example) coupled to spacer slings (e.g., such as the spacer slings 219) to suspend the FIBC from hooks (e.g., such as the hooks 212) on the upper lifting frame (e.g., such as the upper lifting frame 202). Elevation views 1504 illustrate an example of using straps or handles of an FIBC (e.g., such as a 30″×30″ FIBC, in this example) coupled to spacer slings to suspend the FIBC from hooks on the upper lifting frame. Elevation views 1506 illustrate an example of using straps or handles of an FIBC (e.g., such as a 36″×36″ FIBC, in this example) coupled to spacer slings to suspend the FIBC from hooks on the upper lifting frame. In the examples shown in the elevation views 1502, 1504, 1506, the spacer slings may be coupled to the set of more narrowly spaced hooks, each of the differently sized FIBCs resulting in varying loading angles. Top-down view 1508 of the lifter provides more detailed views of the hooks (e.g., such as the hooks 212), handles (e.g., such as the handles 350), and shackles attached to the radiused lifting lug or padeye (e.g., such as the radiused lifting lug or padeye 302).

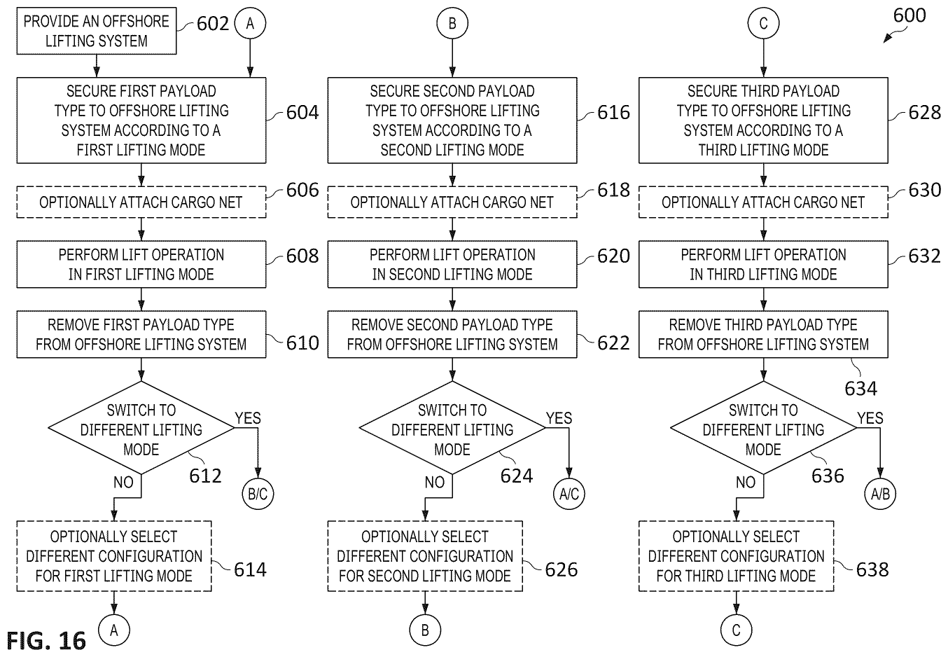

Referring to FIG. 16, illustrated therein is a method 600 of using an offshore lifting system, in accordance with embodiments disclosed herein. The method 600 may be implemented using lifter 200, described above, as well as any of the lifting modes (e.g., IBC mode, FIBC mode, pallet mode) and features associated with the lifter 200 and/or lifting modes such as described with reference to FIGS. 2A-2E, 3-7, 8A-8E, 9A-9B, 10A-10D, and 11-15. Thus, one or more aspects discussed above with reference to the lifter 200, as well as any of the lifting modes or any of the associated features, may also apply to the method 600.

The method 600 begins at block 602 where an offshore lifting system, such as the offshore lifting system 200 (or lifter 200) described above, is provided. The method 600 proceeds to block 604 where a first payload type is secured to the lifter 200 according to a first lifting mode. Generally, and in various embodiments, the first payload type may include an IBC, an FIBC, or a palleted load, and the first lifting mode may include an IBC mode, an FIBC mode, or a pallet mode, respectively. However, for purposes of this example, it will be assumed that the first payload type is an IBC and the first lifting mode is an IBC mode. Thus, in an embodiment of block 604, the upper lifting frame 202 may be brought into position and lowered down over the IBC in order to secure the IBC to the lifter 200. The IBC may be secured to the lifter 200 by using lower lifting bars 214 and slings 216, or by using polyester slings 222, as discussed above. In an example, a rigid push/pull stick or tagline 225 may also be coupled to the lifter 200 to provide for hands-free manipulation of the first payload.

The method 600 proceeds to block 606 where a cargo net 500 is optionally attached to the upper lifting frame 202 (e.g., using the inward facing hooks 212) in order to surround and contain the first payload (e.g., the IBC) during lifting and transport, thereby providing additional load containment and dropped object protection during transport of the first payload. Whether or not a cargo net 500 is used, the method proceeds to block 608 where a lift operation is performed in the first lifting mode (e.g., IBC mode, in this example) to lift, transport, and/or position the first payload (e.g., using an upper sling set 220 attached at the corners of the upper lifting frame 202, the upper sling set 220 further be coupled to a crane, hoist, or other lifting machine). During the lift operation, the rigid push/pull stick or tagline 225 may be used by personnel to control or otherwise manipulate the first payload. After completion of the lift operation, the method proceeds to block 610 where the first payload is removed from the lifter 200 (e.g., by removing the lower lifting bars 214 and slings 216, or by removing the polyester slings 222, and then by raising the upper lifting frame 202 upward and away from the first payload).

After removing the first payload from the lifter 200, the method 600 proceeds to block 612 where personnel may choose whether to switch from the first lifting mode to a different lifting mode. If it is determined (at block 612) not to switch to a different lifting mode and instead to continue lifting the same type of payload (e.g., an IBC, in this example), the method 600 proceeds to block 614 where a different configuration for the first lifting mode (e.g., IBC mode, in this example) is optionally selected. For instance, personnel may choose to switch from using lifting bars 214 and slings 216 to using polyester slings 222 or vice versa. In other cases, personnel may choose to switch the slings 216 for longer or shorter slings based on a size of the IBC tote to be lifted. Whether or not a different configuration for the first lifting mode is selected, the method 600 may then return to block 604, as indicated.

If it is determined (at block 612) to switch from the first lifting mode to a different lifting mode, the method 600 may proceed to either block 616 (second lifting mode) or block 628 (third lifting mode). In various embodiments, the “switching” between lifting modes may include selection of different size slings 216, different size lower lifting bars 214, selection of spacer slings 219, etc. Further, in some examples, fully effectuating the “switching” between lifting modes may occur once the upper lifting frame 202 is brought into position and lowered down over a particular payload type and secured according to the selected different lifting mode.

If it is determined (at block 612) to switch from the first lifting mode to the second lifting mode, the method 600 proceeds to block 616, where a second payload type is secured to the lifter 200 according to a second lifting mode. Generally, and in various embodiments, the second payload type may include an IBC, an FIBC, or a palleted load, and the second lifting mode may include an IBC mode, an FIBC mode, or a pallet mode, respectively. However, for purposes of this example and because the first payload type was assumed to be an IBC, it will be assumed that the second payload type is an FIBC and the second lifting mode is an FIBC mode. Thus, in an embodiment of block 616, the upper lifting frame 202 may be brought into position and lowered down over the FIBC in order to secure the FIBC to the lifter 200. The FIBC may be secured to the lifter 200 by using integrated straps or handles 210 of the FIBC, as discussed above. In an example, a rigid push/pull stick or tagline 225 may also be coupled to the lifter 200 to provide for hands-free manipulation of the second payload.

The method 600 proceeds to block 618 where a cargo net 500 is optionally attached to the upper lifting frame 202 (e.g., using the inward facing hooks 212) in order to surround and contain the second payload (e.g., the FIBC) during lifting and transport, thereby providing additional load containment and dropped object protection during transport of the second payload. In some embodiments, spacer slings 219 may be used as an intermediary coupling between the second payload/cargo net 500 and the upper lifting frame 202, similar to the example described above with reference to FIG. 10B. To be sure, in some cases, the spacer slings 219 may optionally be used even if the cargo net 500 is not used. Whether or not a cargo net 500 is used, the method proceeds to block 620 where a lift operation is performed in the second lifting mode (e.g., FIBC mode, in this example) to lift, transport, and/or position the second payload (e.g., using an upper sling set 220 attached at the corners of the upper lifting frame 202, the upper sling set 220 further be coupled to a crane, hoist, or other lifting machine). During the lift operation, the rigid push/pull stick or tagline 225 may be used by personnel to control or otherwise manipulate the second payload. After completion of the lift operation, the method proceeds to block 622 where the second payload is removed from the lifter 200 (e.g., by detaching integrated straps or handles 210 of the FIBC and/or by detaching the spacer slings 219, and then by raising the upper lifting frame 202 upward and away from the second payload).

After removing the second payload from the lifter 200, the method 600 proceeds to block 624 where personnel may choose whether to switch from the second lifting mode to a different lifting mode. If it is determined (at block 624) not to switch to a different lifting mode and instead to continue lifting the same type of payload (e.g., FIBC, in this example), the method 600 proceeds to block 626 where a different configuration for the second lifting mode (e.g., FIBC mode, in this example) is optionally selected. For instance, personnel may choose to switch from using the wider or outer set of hooks 212 to the narrow or inner set of hooks 212, or vice versa, based on a size of the FIBC to be lifted. In other cases, personnel may switch to using spacer slings 219 (if not previously used), or may switch to not using spacer slings 219 (if previously used). Whether or not a different configuration for the second lifting mode is selected, the method 600 may then return to block 616, as indicated.

If it is determined (at block 624) to switch from the second lifting mode to a different lifting mode, the method 600 may proceed to either block 604 (first lifting mode) or block 628 (third lifting mode). If it is determined (at block 624) to switch from the second lifting mode to the first lifting mode, the method 600 proceeds to block 604, where a first payload type is secured and lifted, as previously described. If it is determined (at block 624) to switch from the second lifting mode to the third lifting mode, the method 600 proceeds to block 628, where a third payload type is secured to the lifter 200 according to a third lifting mode. It is noted that the method may similarly proceed to block 628 if it is determined (at block 612) to switch from the first lifting mode to the third lifting mode, in some embodiments. Generally, and in various embodiments, the third payload type may include an IBC, an FIBC, or a palleted load, and the third lifting mode may include an IBC mode, an FIBC mode, or a pallet mode, respectively. However, for purposes of this example and because the first payload type was assumed to be an IBC and the second payload type was assumed to be an FIBC, it will be assumed that the third payload type is a palleted load and the third lifting mode is a pallet mode. Thus, in an embodiment of block 628, the upper lifting frame 202 may be brought into position and lowered down over the palleted load in order to secure the palleted load to the lifter 200. The palleted load may be secured to the lifter 200 by using lower lifting bars 214 and slings 216, as discussed above. As previously discussed, sizes of the lower lifting bars 214 and slings 216 may vary based on the size of the pallet (e.g., such as a pallet size of about 40″×48″ or about 48″×48″). In an example, a rigid push/pull stick or tagline 225 may also be coupled to the lifter 200 to provide for hands-free manipulation of the third payload.

The method 600 proceeds to block 630 where a cargo net 500 is optionally attached to the upper lifting frame 202 (e.g., using the inward facing hooks 212) in order to surround and contain the third payload (e.g., the palleted load) during lifting and transport, thereby providing additional load containment and dropped object protection during transport of the third payload. Whether or not a cargo net 500 is used, the method proceeds to block 632 where a lift operation is performed in the third lifting mode (e.g., pallet mode, in this example) to lift, transport, and/or position the third payload (e.g., using an upper sling set 220 attached at the corners of the upper lifting frame 202, the upper sling set 220 further be coupled to a crane, hoist, or other lifting machine). During the lift operation, the rigid push/pull stick or tagline 225 may be used by personnel to control or otherwise manipulate the third payload. After completion of the lift operation, the method proceeds to block 634 where the third payload is removed from the lifter 200 (e.g., by removing the lower lifting bars 214 and slings 216, and then by raising the upper lifting frame 202 upward and away from the third payload).

After removing the third payload from the lifter 200, the method 600 proceeds to block 636 where personnel may choose whether to switch from the third lifting mode to a different lifting mode. If it is determined (at block 636) not to switch to a different lifting mode and instead to continue lifting the same type of payload (e.g., a palleted load, in this example), the method 600 proceeds to block 638 where a different configuration for the third lifting mode (e.g., pallet mode, in this example) is optionally selected. For instance, personnel may choose to switch from using the wider or outer set of hooks 212 to the narrow or inner set of hooks 212, or vice versa, based on a size of the palleted load to be lifted. In other cases, personnel may choose to switch a size of the lower lifting bars 214 and/or a size of the slings 216 based on a size of the palleted load to be lifted. Whether or not a different configuration for the third lifting mode is selected, the method 600 may then return to block 628, as indicated.

If it is determined (at block 636) to switch from the third lifting mode to a different lifting mode, the method 600 may proceed to either block 604 (first lifting mode) or block 616 (second lifting mode). If it is determined (at block 636) to switch from the third lifting mode to the first lifting mode, the method 600 proceeds to block 604, where a first payload type is secured and lifted, as previously described. Similarly, if it is determined (at block 636) to switch from the third lifting mode to the second lifting mode, the method 600 proceeds to block 616, where a second payload type is secured and lifted, as previously described.

It will be understood that, in various embodiments, additional steps may be implemented before, during, and/or after the method 600, and some steps may be replaced or eliminated in accordance with various embodiments of the method 600. For example, in some cases, a given payload may be secured to the lifter according to a particular lifting mode in a particular configuration, then the given payload may be subsequently unsecured, the particular configuration of the particular lifting mode may be changed to a different configuration, and the given payload may be resecured to the lifter according to the particular lifting mode in the different configuration, all without actually performing a lift operation. Various other modifications to the method 600 are possible and will become apparent to one skilled in the art having benefit of the present disclosure.

Thus, systems and methods have been provided for lifting IBCs, FIBCs, and palleted loads using a multi-purpose offshore lifting system. In various embodiments, the multi-purpose offshore lifting system is generally capable of operating in three different modes (e.g., depending on a configuration of the system) including an IBC mode (or tote mode), an FIBC mode, and a pallet mode. The disclosed offshore lifting system includes an upper lifting frame from which an IBC, an FIBC, or a pallet may be suspended as a payload. In various cases, the lifter and payload (e.g., such as an IBC, FIBC, or palleted load) may be lifted and transported using a sling set attached at corners of the upper lifting frame, the sling set further coupled to a crane, hoist, or other lifting machine. The offshore lifting system and rigging arrangement may also provide for full load containment for IBC, FIBC, and palleted loads, for example, by having the offshore lifting system swallow, surround, or otherwise encapsulate the load. In the IBC lifting mode, the offshore lifting system protects against potential lateral loading (e.g., such as when transporting fluids) by ensuring that the upper lifting frame of the offshore lifting system fully encapsulates the IBC tote. In the FIBC lifting mode, the upper lifting frame may also be configured to allow for attachment of a cargo net that surrounds and contains an FIBC bag during transport, thereby providing dropped object protection in the event that handles of the FIBC bag were to break. In some cases, in the IBC lifting mode or in a pallet lifting mode, a cargo net may similarly be used to surround and contain an IBC tote or a palleted load during transport, to provide an additional layer of containment and support. The embodiments disclosed herein significantly mitigate the potential risk of personal injury, as well as the potential for damage to the below-the-hook lifting device and/or the load itself. As a result, overall safety and productivity are greatly enhanced.

The foregoing is not intended to limit the present disclosure to the precise forms or particular fields of use disclosed. As such, it is contemplated that various alternate embodiments and/or modifications to the present disclosure, whether explicitly described or implied herein, are possible. Persons of ordinary skill in the art in possession of the present disclosure will recognize that changes may be made in form and detail without departing from the scope of what is claimed.

What is claimed is:

1. An offshore lifting system, comprising:
an upper lifting frame;
a radiused lifting lug disposed at each corner of the upper lifting frame and along a top surface of the upper lifting frame; and
a plurality of weld-on hooks attached to opposing interior surfaces of the upper lifting frame and adjacent to corners of the upper lifting frame;
wherein, in a first configuration of a first mode of operation, a pair of lower lifting bars are suspended from slings of a first length coupled to respective ones of the plurality of weld-on hooks along the opposing interior surfaces of the upper lifting frame, and wherein the upper lifting frame and the lower lifting bars are configured for lateral and vertical containment of a rigid container; and
wherein, in a second mode of operation, lifting handles of a flexible container are configured for attachment to respective first ones of the plurality of weld-on hooks at each corner of the upper lifting frame, wherein a cargo net is attached to respective second ones of the plurality of weld-on hooks at each corner of the upper lifting frame, and wherein the cargo net surrounds and contains the flexible container.

2. The offshore lifting system of claim 1,
wherein, in a second configuration of the first mode of operation, a pair of polyester slings are coupled to the respective ones of the plurality of weld-on hooks along the opposing interior surfaces of the upper lifting frame, and wherein the upper lifting frame and the pair of polyester slings are configured for lateral and vertical containment of the rigid container.

3. The offshore lifting system of claim 1,
wherein, in a third mode of operation, the pair of lower lifting bars are suspended from slings of a second length coupled to respective ones of the plurality of weld-on hooks along the opposing interior surfaces of the upper lifting frame, wherein the second length is longer than the first length, and wherein the upper lifting frame and the lower lifting bars are configured for containment of a palleted load.

4. The offshore lifting system of claim 3, wherein the pair of lower lifting bars used in the third mode of operation are longer than the pair of lifting bars used in the first configuration of the first mode of operation.

5. The offshore lifting system of claim 1, wherein the upper lifting frame has a substantially square shape from a top view.

6. The offshore lifting system of claim 1, wherein the rigid container includes an intermediate bulk container (IBC) and the flexible container includes a flexible IBC (FIBC).

7. The offshore lifting system of claim 1, wherein each of the radiused lifting lugs are configured for attachment of a respective sling for coupling the upper lifting frame to a master link assembly, and wherein each of the respective slings configured for attachment to each of the radiused lifting lugs has an equal length.

8. The offshore lifting system of claim 1, wherein the upper lifting frame includes one or more handles coupled to a top surface of the upper lifting frame.

9. The offshore lifting system of claim 1, further comprising:
a bumper attached to an interior surface of a side of the upper lifting frame between a set of weld-on hooks of the plurality of weld-on hooks attached at opposing lateral ends of the interior surface along the side of the upper lifting frame, wherein the bumper includes a cylindrical pipe with a radiused surface.

10. A lifting device, comprising:
a rectilinear frame assembly, wherein the rectilinear frame assembly circumscribes a payload region at least from a top-down view of the lifting device, and wherein the payload region is configured to receive a payload;
padeyes protruding from a top portion of the rectilinear frame assembly at each corner of the rectilinear frame assembly;
a plurality of hooks attached to an interior surface of the rectilinear frame assembly and adjacent to each corner of the rectilinear frame assembly, wherein first ones of the plurality of hooks are configured to support the payload; and
an upper sling set attached to respective ones of the padeyes, wherein the rectilinear frame assembly and the payload are configured to be lifted using the upper sling set.

11. The lifting device of claim 10, wherein each sling of the upper sling set has an equal length.

12. The lifting device of claim 10, further comprising:
a bumper attached to at least two opposing interior surfaces of the rectilinear frame assembly, wherein the bumper includes a cylindrical pipe with a radiused surface.

13. The lifting device of claim 10, further comprising:
a first lifting bar suspended from first and second vertical slings coupled to first and second hooks of the plurality of hooks, the first and second hooks attached to opposing interior surfaces of the rectilinear frame assembly; and
a second lifting bar suspended, parallel to the first lifting bar, from third and fourth vertical slings coupled to third and fourth hooks of the plurality of hooks, the third and fourth hooks attached to the opposing interior surfaces of the rectilinear frame assembly;
wherein the rectilinear frame assembly and the first and second lifting bars are configured for lateral and vertical containment of the payload.

14. The lifting device of claim 10, further comprising:
a first polyester sling coupled to first and second hooks of the plurality of hooks, the first and second hooks attached to opposing interior surfaces of the rectilinear frame assembly; and
a second polyester sling coupled to third and fourth hooks of the plurality of hooks, the third and fourth hooks attached to opposing interior surfaces of the rectilinear frame assembly;
wherein the rectilinear frame assembly and the first and second polyester slings are configured for lateral and vertical containment of the payload.

15. The lifting device of claim 10, further comprising:
a cargo net coupled to and suspended from second ones of the plurality of hooks adjacent to each corner of the rectilinear frame assembly, wherein the cargo net is configured to surround and contain the payload.

16. The lifting device of claim 15, wherein the cargo net includes an opening aligned with a bottom portion of the payload.

17. The lifting device of claim 15, wherein the payload includes a flexible container having lifting handles, and wherein the lifting device further comprises:
spacer slings having first ends coupled to the first ones of the plurality of hooks adjacent to each corner of the rectilinear frame assembly, the spacer slings further having second ends coupled to both the handles of the flexible container and the cargo net.

18. The lifting device of claim 10, further comprising:
one or more handles attached to a top side of the rectilinear frame assembly.

19. A lifting device, comprising:
a rectilinear lifting frame having plural sides, wherein each of the plural sides includes an interior surface that faces an opposing interior surface of another one of the plural sides;
a first set of inward facing hooks attached to the interior surface at lateral ends of a first one of the plural sides adjacent to first and second corners of the rectilinear lifting frame; and
a second set of inward facing hooks attached to the interior surface at lateral ends of a second one of the plural sides adjacent to third and fourth corners of the rectilinear lifting frame, wherein the first one of the plural sides faces the second one of the plural sides.

20. The lifting device of claim 19,
wherein a region circumscribed by the rectilinear lifting frame is configured to receive a payload, and wherein the plural sides of the rectilinear lifting frame are configured to laterally contain the payload.

21. The lifting device of claim 19, further comprising:
a radiused padeye extending from a top side of the rectilinear lifting frame at each of the first, second, third, and fourth corners, wherein the radiused padeyes are configured for attachment of a set of slings by which the rectilinear lifting frame and a payload are lifted, and wherein each sling of the set of slings has an equal length.

22. The lifting device of claim 19, further comprising:
a first bumper attached to the interior surface of the first one of the plural sides between the first set of inward facing hooks; and
a second bumper attached to the interior surface of the second one of the plural sides between the second set of inward facing hooks;
wherein the first and second bumpers include a cylindrical pipe with a radiused surface.

23. The lifting device of claim 19, further comprising:
a first lower lifting bar suspended from first and second slings coupled to first and second inward facing hooks of respective ones of the first and second sets of inward facing hooks; and
a second lower lifting bar suspended, parallel to the first lower lifting bar, from third and fourth slings coupled to third and fourth inward facing hooks of respective ones of the first and second sets of inward facing hooks.

24. The lifting device of claim 23, further comprising:
a cargo net coupled to and suspended from inward facing hooks next to each of the first, second, third, and fourth inward facing hooks and adjacent to each of the first, second, third, and fourth corners, wherein the cargo net is configured to surround and contain the first and second lower lifting bars and a payload received within a region circumscribed by the rectilinear lifting frame.

25. The lifting device of claim 19, further comprising:
a handle attached to a top side of the rectilinear lifting frame and adjacent to each inward facing hook of the first and second sets of inward facing hooks.
